(19) United States
(12) Patent Application Publication
(10) Pub. No.: US 2006/0090207 A1
(43) Pub. Date: Apr. 27, 2006

(54) Content distribution system, content distribution method and content reception device

(76) Inventors: Hironori Tomita, Ikoma-shi (JP); Tohru Nakamura, Katano-shi (JP); Hideki Aikoh, Higashiosaka-shi (JP)

Correspondence Address: WENDEROTH, LIND & PONACK, L.L.P., 2033 K STREET N. W., SUITE 800, WASHINGTON, DC, 20006-1021, US

(21) Appl. No.: 10/535,194

(22) PCT Filed: Nov. 17, 2003
(86) PCT No.: PCT/JP03/14557

§ 371 Date: May 18, 2005

(30) Foreign Application Priority Data
Nov. 19, 2002 (JP) 2002-334837

(51) Int. Cl. H04N 7/16

(52) U.S. Cl. 726/26

(57) ABSTRACT

This invention relates to a content distribution system, a content distribution method and a content receiving device and one of the objects thereof are to enable a higher investment efficiency regarding content of manufacturers. In order to achieve the object, the content distribution system includes a content receiving device (21A, 22A, 23A) for receiving and reproducing encrypted content created by using a budget provided by manufacturer, the content receiving device (21A, 22A, 23A) comprising a receiving means 91 for receiving the content, an input means (93) for inputting a decryption key given owing to purchase of a product made by the manufacturer, a decryption means (96) for decrypting, upon input of the decryption key by the input means (93), an encryption of the content received by the receiving means (93) by use of the decryption key; and a viewing means (92) for reproducing the content decrypted by the decryption means (96).

### TECHNICAL FIELD

The present invention relates to a content distribution system, a content distribution method and a content reception device.

### BACKGROUND ART

An exemplary conventional content distribution system is below described with reference to drawings. FIG. 22 is a block diagram showing a configuration of a conventional distribution system 200 for a television (TV) program broadcast by a commercial station. In the distribution system 200, a content holder 240 that stores and distributes content to be distributed is a television station (TV) 211. The television station 211 has an information distribution device 210 for distributing contents 241 to 243 which include television (TV) programs produced by them. A television receiver 222 is a device for receiving content distributed by the information distribution device 210 of the TV station 211. Audience 201 can view the TV programs (content) displayed on the television receiver 222.

In the case of commercial broadcasting, for example, conventional contents such as terrestrial or satellite broadcast television programs is usually made by each TV station 211 or content maker, etc., and is distributed after being attached with commercial messages or CM (advertising programs) of manufacturers 231, 232 (any kind of maker being hereinafter called “manufacturer” irrespective of the type of products manufactured, including hardware. Audience 201 can hear and see TV programs (content) according to their preferences.

On the one hand, the TV station 211 collects CM broadcast fees from manufacturers 231 and 232 and uses the collected fees to make TV programs (contents). FIG. 22 shows an example wherein the manufacturer 231 pays CM broadcast fees with respect to the contents 241 and 242, which fees cover the making cost for contents 241 and 242, and another example wherein the manufacturer 232 pays CM broadcast fees with respect to contents 242 and 243, which fees cover the making cost for contents 242 and 243.

Also, a part of the sum paid by consumer 202 to purchase products made by the manufacturer 231 or 232 is used by the manufacturer 231 or 232 to pay the CM broadcast fee.

In the conventional distribution system 200 for terrestrial broadcast TV programs, the TV station makes TV programs (contents) and furthermore, needs to make commercial messages for products (including services) associated with manufacturers 231, 232 in the space between TV program makings, therefore having to cover making costs for such commercial messages.

When selecting and allowing broadcasting of commercial message for audience 201 who is assumed in connection with the contents of the TV program, the manufacturer 231 or 232 assumes that the audience 201 is consumers 202, and therefore advertises its own products. Manufacturer 231 or 232 estimates how many of its products have appealed to the consumer 202 (=audience 201) based on the viewing rate of the TV programs containing the commercial message. However, although the favoritism of the audience 201 for a TV program can be determined up to a certain degree from the viewing rate, the audience 201 of the TV program and the actual buyer (consumer 202) of the products do not necessarily coincide, reason for which the manufacturers 231 and 232 found the correlation between investment in TV programs (CM broadcast fee) and sales turnover (profit) of advertised products to be ambiguous.

Also, when the audience 201 views the TV programs of their choice, he/she is forcibly made to view the commercial messages of manufacturers 231 or 232 (or of products made by such manufacturers) or have interrupt viewing of the content due to commercial messages broadcast, irrespective of any such necessity.

The existence of an audience 201 who does not want to see any commercial messages during his/her viewing of TV programs can also be understood from the fact that there exist some home VTRs for TV program recording having a function which allows the VTR to reproduce the recorded program skipping the commercial messages.

### DISCLOSURE OF THE INVENTION

This invention was worked out to solve the above-described problems and an object thereof is to provide a content distribution system, a content distribution method and a content receiving device by which manufacturers can improve efficiency of investment in content and audience can view TV programs, etc. without any need to interrupt such viewing.

To accomplish the aforementioned objects, according to an aspect of the present invention, provided is a content receiving device which is operable to receive and reproduce content which is made by a content holder using a budget provided by a single manufacturer or a plurality of manufacturers, and then encrypted, and includes a receiving means for receiving the content, an input means for inputting a decryption key delivered upon purchasing products of the manufacturer(s), a decryption means for decrypting the content received by the receiving means upon inputting the decryption key from the input means and an audiovisual means for reproducing the content decrypted by the decryption means.

Objects, characteristics, aspects and advantages of this invention will become clearer from the following detailed description and accompanying drawings.

### BRIEF DESCRIPTION OF THE DRAWINGS

FIG. 1 is a block diagram showing a configuration of a content distribution system according to a first embodiment of the invention;

FIG. 2 is a block diagram illustrating an example of a hardware configuration of an information distribution device shown in FIG. 1;

FIG. 3 is a block diagram showing a configuration based on main functions of the information distribution device shown in FIG. 1;

FIG. 4 is a block diagram illustrating an example of a hardware configuration of a content receiving device shown in FIG. 1;

FIG. 5 is a block diagram showing a configuration based on main functions of the content receiving device shown in FIG. 1;

FIG. 6 is a flow chart describing the operation of the content distribution system shown in FIG. 1;

FIG. 7 is a block diagram showing an example of a hardware configuration of a manufacturer terminal shown in FIG. 1;

FIG. 8 is a flow chart showing an example of a processing sequence of information exchange between the manufacturer terminal and the content receiving device shown in FIG. 1;

FIG. 9 is a flow chart showing another example of a processing sequence of information exchange between the manufacturer terminal and the content receiving device shown in FIG. 1;

FIG. 10 is a flow chart showing yet another example of a processing sequence of information exchange between the manufacturer terminal and the content receiving device shown in FIG. 1;

FIG. 11 is a block diagram showing a configuration of a content distribution system according to a second embodiment of the invention;

FIG. 12 is a block diagram showing a configuration based on main functions of an information distribution device shown in FIG. 11;

FIG. 13 is a block diagram illustrating a configuration based on main functions of a content receiving device shown in FIG. 11;

FIG. 14 is a flow chart describing the operation of the content distributing system shown in FIG. 11;

FIG. 15 is a block diagram showing a configuration of a content distribution system according to a third embodiment of the invention;

FIG. 16 is a flow chart showing an example of a processing sequence of information exchange between the manufacturer terminal and the content receiving device shown in FIG. 15;

FIG. 17 is a block diagram showing a configuration of a content distribution system according to a fourth embodiment of the invention;

FIG. 18 is a flow chart showing an example of a processing sequence of information exchange between the manufacturer terminal and the content receiving device shown in FIG. 17;

FIG. 19 is a block diagram showing a configuration of a content distribution system according to a fifth embodiment of the invention;

FIG. 20 is a flow chart showing an example of a processing sequence of information exchange between the manufacturer terminal and the content receiving device shown in FIG. 19;

FIG. 21 is a block diagram showing a configuration of a content distribution system according to a sixth embodiment of the invention;

FIG. 22 is a block diagram showing a configuration of a content distribution system according to the prior art.

### BEST MODE FOR CARRYING OUT THE INVENTION

Embodiments of the present invention are next described with reference to the drawings.

### FIRST EMBODIMENT

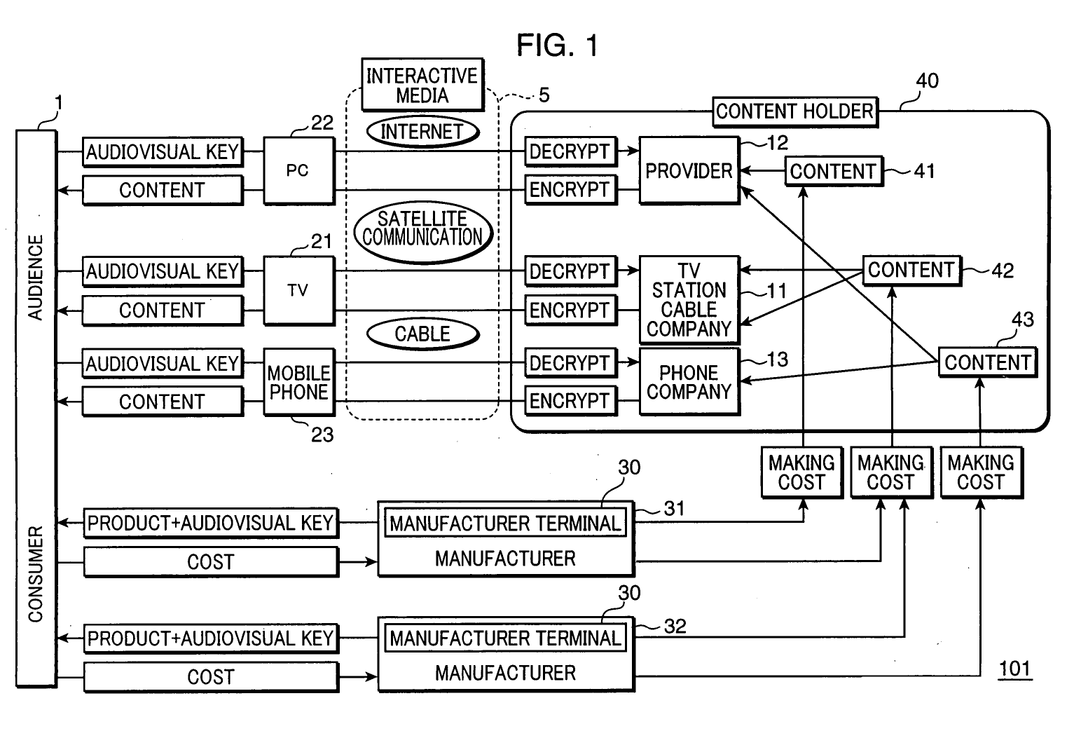

FIG. 1 is a block diagram illustrating the configuration of a content distribution system according to a first embodiment of the present invention. A content distribution system 101 comprises an information distribution device 11 which is a device for distributing content via satellite communications or the like which is an example of a communications line 5. As a content holder 40 who holds and distributes the content that is to be distributed, and has the information distribution device 11, for example, TV stations, cable TV companies or the like may be considered. An information distribution device 12 is a device for distributing content via the Internet or the like which is an example of the communications line 5. As the content holder 40 who has the information distribution device 12, for example, Internet providers, etc. may be considered. An information distribution device 13 is a device for distributing content via cable line or the like which is an example of the communications line 5. As the content holder 40 who has the information distribution device 13, for example, phone companies, etc. may be considered.

The information distribution device 11 sends encrypted content to a content receiving device 21 that includes a TV (television) monitor screen via communications line 5 such as satellite communications. The information distribution system 12 sends encrypted content to a content receiving device 22 that includes a personal computer (PC) via a communications line 5 such as the Internet. The information distribution system 13 sends encrypted content to a content receiving device 23 which includes a mobile phone via the communications line 5 such as a communication cable, radio waves or the like. Audience 1 can see and hear the content reproduced by the content receiving devices 21, 22 or 23. Between the information distribution device 11 and the content receiving device 21, between the information distribution device 12 and the content receiving device 22, between the information distribution device 13 and the content receiving device 23, respectively, information can be transmitted in a two-way communication.

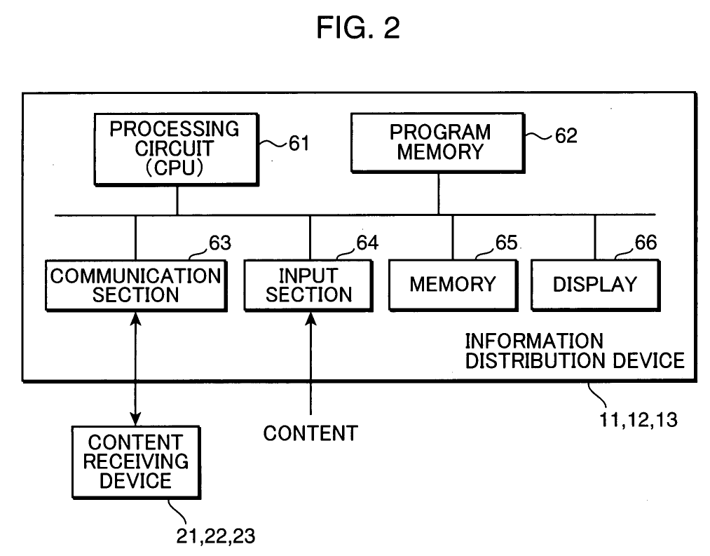

FIG. 2 is a block diagram illustrating an example of hardware configuration of the information distribution devices 11, 12 and 13. In FIG. 2, the information distribution devices 11, 12 and 13 are each provided with a processing circuit 61, a program memory 62, a communication section (sending/receiving section) 63, an input section 64, a memory 65 and a display 66. In other words, the information distribution devices 11, 12 and 13 have a computer. The processing circuit 61 is a circuit for processing information, and comprises a CPU (central processing unit), an arithmetic circuit and the like. The program memory 62 is a memory for storing programs that control the operation of the CPU and has, for instance, an external memory such as hard disk or semiconductor memory, etc. The communication section 63 performs the sending and receiving of information between itself and each of the content receiving devices 21, 22 and 23 and has a modem, for example.

The input section 64 is adapted for inputting information, and comprises a keyboard, a mouse and the like. The input section 64 is also provided with an interface for inputting information such as content, etc. The memory 65 includes storage media such as a hard disk and stores content which is to be distributed. The display 66 is adapted for displaying information such as content, etc., and is provided with a display device such as a cathode-ray tube (CRT), a liquid crystal display or the like. Programs which are stored in the program memory 62 and are to be executed by the CPU provided inside the processing circuit 61 can be provided via a memory medium such as ROM, CD-ROM or the like, or they can also be provided via a transmission medium such as a communications line or the like.

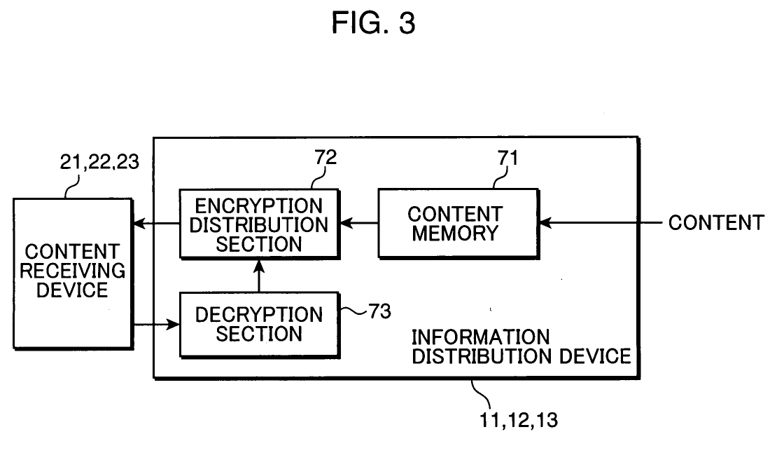

FIG. 3 is a block diagram showing a configuration based on the main functions of the information distribution device 11, 12 or 13. The information distribution devices 11, 12 and 13 are each provided with a content memory 71, an encryption distribution section 72 and a decryption section 73. The content memory 71 stores the content to be distributed. The encryption distribution section 72 encrypts content that is to be stored in the content memory 71, and then distributes the encrypted content to the content receiving device 21, 22 or 23. The encryption distribution section 72 may distribute the content in response to a request from the content receiving devices 21, 22 and 23, or it may also distribute content defined on a time basis according to predetermined programs. The latter manner has the benefit that the load on the information distribution devices 11, 12 and 13 is light. When an audiovisual key functioning as a decryption key is sent from the content receiving device 21, 22 or 23, the decryption section 73 decrypts, in response to the audiovisual key, the encryption of the content to be distributed by the encryption distribution section 72. Thereby, the encryption distribution section 72 distributes decrypted content to the content receiving device 21, 22 or 23 that sent the audiovisual key.

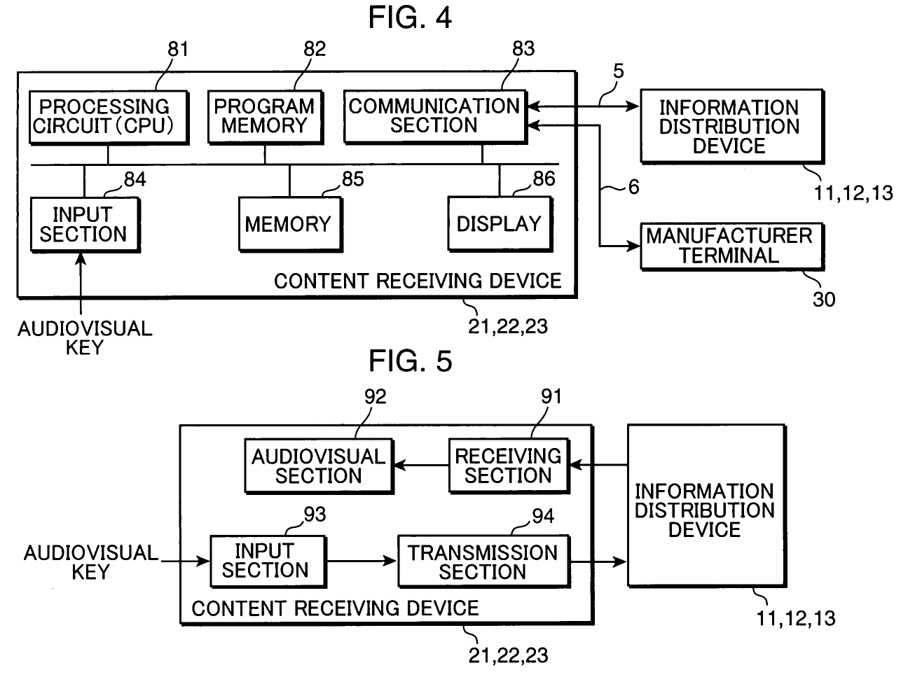

FIG. 4 is a block diagram showing an example of hardware configuration of the content receiving device 21, 22 or 23. In the example of FIG. 4, the content receiving devices 21, 22 and 23 are each provided with a processing circuit 81, a program memory 82, a communication section (sending/receiving section) 83, an input section 84, a memory 85 and a display 86. In other words, each of the content receiving devices 21, 22 and 23 has a computer. The processing circuit 81 is a circuit for processing information, and comprises a CPU, an arithmetic circuit and the like. The processing circuit 81 also comprises a circuit for reproducing the received content on the display 86. The program memory 82 includes a memory for storing programs that control the operation of the CPU and has, for instance, an external memory such as hard disk or semiconductor memory, etc.

The communication section 83 performs sending and receiving of information between itself and the corresponding information distribution device 11, 12 or 13 via the communications line 5, and has a modem or the like. As further described in a modified example, in the case that manufacturer 31 or 32 has a manufacturer terminal 30 (refer to FIG. 1), the communication section 83 can also execute the transmission of information between itself and the manufacturer terminal 30 via a communications line 6 such as internet, etc. The input section 84 is adapted for inputting information, and comprises a remote control (an input device enabling remote manipulation by transmission of radio waves, infrared rays or the like), a keyboard, a mouse, dial buttons and the like. An audiovisual key is input to the content receiving device 21, 22 or 23 via the input section 84. The input section 84 may be configured such that a user can input the contents of the audiovisual key manually. It may also be configured so as to automatically read the contents of the audiovisual key by providing a card reader, or the like.

The memory 85 has, for example, a semiconductor memory, and can hold the content of the inputted audiovisual key. The display 86 displays information such as content, etc. for the audience, in other words, reproduces information such as content, etc., and has an image display device such as a CRT, a liquid crystal display, etc., and a speech output device such as a speaker, etc. Programs which are stored in the program memory 82 and are to be executed by the CPU provided inside the processing circuit 81 can be provided via a memory medium such as ROM, CD-ROM or the like, or they can also be provided via a transmission medium such as a communications line or the like.

FIG. 5 is a block diagram showing a configuration based on the primary functions of the content receiving devices 21, 22 and 23. The content receiving devices 21, 22 and 23 are each provided with a receiving section 91, an audiovisual section 92, an input section 93 and a transmission section 94. The receiving section 91 receives the content sent from the information distribution device 11, 12 or 13. The audiovisual section 92 reproduces the received content. In other words, the audiovisual section 92 displays the received content on the display 86. The input section 93 allows an inputting operation of the audiovisual key. The transmission section 94 sends the inputted audiovisual key to the information distribution device 11, 12 or 13 of the content holder 40.

The content is made by each TV station, content maker, etc. respectively. However, audience 1 cannot see and hear content in the encrypted state by means of the speaker, display screen, etc. of the display 86 provided in the content receiving device 21, 22 or 23. In order to decrypt the content, the audience 1 must input an audiovisual key functioning as a decryption key via the input section 93 (or 83) of the content receiving device 21, 22 or 23.

As shown in FIG. 1, the making cost of contents 41, 42 or 43 is partly or entirely covered by manufacturers 31 and 32 similarly to terrestrial TV broadcast. Making costs for some contents (content 42 in FIG. 1) may of course be shared among plural manufacturers 31 and 32.

On the one hand, when consumer 1 purchases products (including services) associated with the manufacturer 31 or 32, the manufacturer 31 or 32 gives an audiovisual key out to the consumer 1. Consequently, upon receiving the audiovisual key, the consumer becomes an audience and sees and hears the content decrypted by the audiovisual key. For this reason, the same code is provided to the consumer and audience. A variety of audiovisual key distribution ways may be considered, such as: writing down a code number corresponding to the audiovisual key on the product guarantee certificate, using a manufacturer's serial number of the product as a code number corresponding to the audiovisual key, having the consumer fill out a survey sheet for the purchased product and later informing the consumer of the audiovisual key by sending mail to the consumer's address, embedding electronic information in an IC chip such as a memory card readable by the content receiving devices 21, 22 and 23 at home and delivering the memory card or the like to the consumer 1 by packaging it with the product, or giving the audiovisual key directly by manufacturer 31 or 32 or at product distributors, etc.

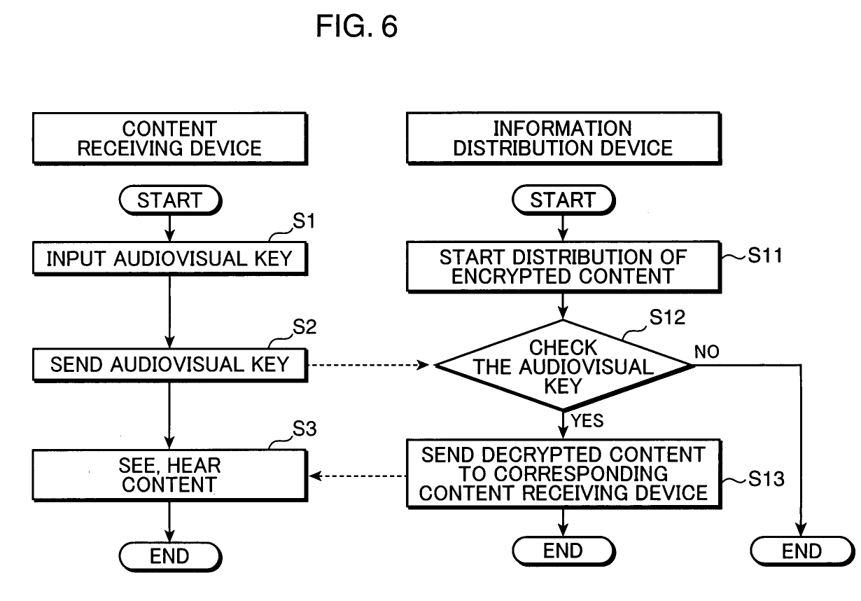

FIG. 6 is a flow chart describing the operation of the content distribution system 101 according to the first embodiment of the present invention. In the content distribution system 101, the consumer 1 or audience 1 first inputs the given audiovisual key to the input section 93 of the content receiving device 21, 22 or 23 (S1). In other words, the input section 93 allows the audiovisual key to be inputted by the audience 1. Subsequently, the transmission section 94 sends the audiovisual key to the information distribution device 11, 12 or 13 of the content distribution source (or a company or the like consigned by the content distribution source) such as internet service providers, TV stations, cable TV companies, phone companies or the like (S2).

In the information distribution device 11, 12 or 13, before the above operation, the encryption distribution section 72 may initiate the distribution of the encrypted content according to a program or in response to an audiovisual request from the content receiving device 21, 22 or 23 (S11). When the decryption section 73 of the information distribution device 11, 12 or 13 receives the audiovisual key sent by the transmission section 94, it first checks whether the audiovisual key is appropriate (S12). Information regarding the delivered audiovisual key which has been sent in advance from the manufacturer 31 or 32 who sells products is referenced in order to determine whether the audiovisual key is appropriate or not. Every time being generated, such reference information may be preferably stored in the memory 65 as database. If the sent audiovisual key is not appropriate, the decryption section 73 sends to the corresponding content receiving device 21, 22 or 23 the information that the audiovisual key is not appropriate, and terminates the processing. At this time, the encryption distribution section 72 may send the encrypted content as it is to the particular content receiving device 21, 22 or 23 that had transmitted the audiovisual key, or it may suspend the transmission to the particular content receiving device 21, 22 or 23.

If the sent audiovisual key is appropriate, the decryption section 73 decrypts the content to be sent to the particular content receiving device 21, 22 or 23 which had transmitted the audiovisual key. As a result, the encryption distribution section 72 sends the decrypted content to the particular content receiving device 21, 22 or 23 (S13). At this point, the encryption distribution section 72, instead of initiating the content distribution at step S11, may initiate the distribution of the content to the corresponding content receiving devices 21, 22 or 23. In this case, the encryption distribution section 72 carries out the distribution of the content to the corresponding content receiving device 21, 22 or 23 in the state where the content has initially been decrypted.

The receiving section 91 of the corresponding content receiving device 21, 22 or 23 can thereby receive content which is not encrypted, and the audiovisual section 92 can reproduce the content which is not encrypted (S3). As a result, the audience 1 can see and hear the content such as image, music by means of the display screen or speaker of the display 86.

The content distribution system 101 operates as described above, which thereby causes an added value that the consumer 1 can see and hear specific contents at the time of purchasing the necessary product, and the manufacturers 31, 32 have an appeal point over competitors' products due to the fact that when consumers purchase their own products, they can see and hear the content.

If the content to be distributed is configured to leave out commercial messages from the contents of programs for terrestrial television broadcast, for instance, the manufacturers 31, 32 can reduce making costs because there is no need for new content, and audience 1 can see and hear programs on terrestrial television broadcast without any commercial messages during the programs. The manufacturers 31, 32 give the consumer 1 the audiovisual key for the programs whose making costs they covered and which are distributed accompanied by commercial messages. Consumers that have purchased products of the manufacturers 31, 32 no longer need the commercial messages of the manufacturers 31, 32 and television programs having no commercial messages become appealing. Also, for the manufacturers 31, 32, it is hardly beneficial to have the audience 1 who purchased their products continue to see and hear their company's commercial messages.

Also, it can be assumed with a high certainty that the consumer 1 who received the audiovisual key is the audience 1 who have seen and heard the earlier television program which is originally in connection with the content that can be viewed by the audiovisual key, and who have seen the commercial message accompanying the television program to thereby decide the purchase of the product. Accordingly, the manufacturers 31, 32 can confirm the advertising effect, and can make the decision of providing subsequent making costs to the content holder 40. In this way, in the content distribution system 101 according to this embodiment, the relationship between the consumer and the audience is established with a considerable degree of certainty. Accordingly, the manufacturers 31, 32 can ensure improved investment efficiency because a higher correlation between investment (making cost) for the content and product sales turnover (profit) is obtained.

### Modified Example of the First Embodiment: Internet Retailing

In the case where consumer 1 purchases products by mail using the internet, manufacturers 31, 32, internet providers or mail-order houses can send an e-mail including contents of the audiovisual key to the content receiving device 21, 22 or 23 which functions as audience 1 (consumer 1) terminal, and further enabling viewing of the content distributed via the internet by using the audiovisual key, which thus provides a distribution system with a high affinity for the internet.

For this reason, it is preferable that manufacturers 31 and 32 each have a manufacturer terminal 30 as shown in FIG. 1. Internet provider or mail-order house may have the manufacturer terminal 30 instead of or as well as the manufacturers 31, 32. Either of the cases, for convenience, is referred to as the manufacturer terminal.

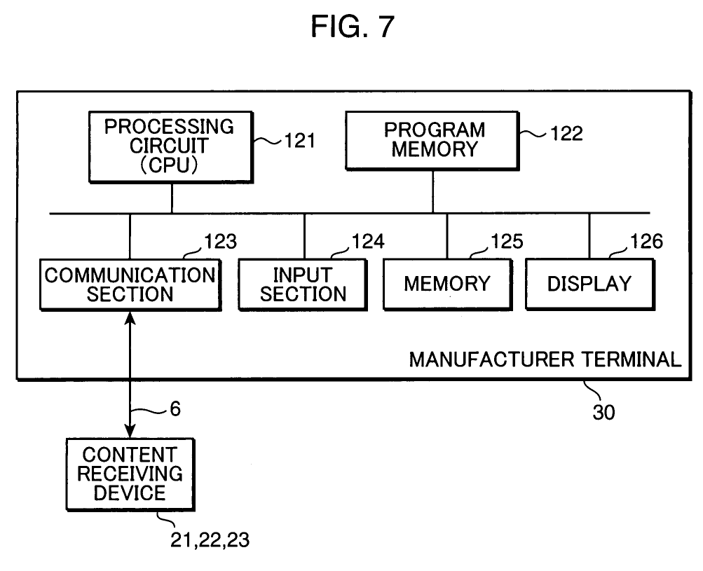

FIG. 7 is a block diagram showing an example of a hardware configuration of a manufacturer terminal 30. In this example, the manufacturer terminal 30 is provided with a processing circuit 121, a program memory 122, a communication section (sending and receiving section) 123, an input section 124, a memory 125 and a display 126. In other words, the manufacturer terminal 30 has a computer. The processing circuit 121 is a circuit for processing information, and comprises a CPU, an arithmetic circuit and the like. The program memory 122 is a memory that stores programs which regulate the operation of the CPU and has, for instance an external memory such as hard disk or a semiconductor memory, etc. The communication section 123 performs sending and receiving of information between itself and each of the content receiving devices 21, 22 and 23, and has a modem, for example. The input section 124 inputs information and comprises a keyboard, a mouse and the like.

The memory 125 includes a memory medium such as a hard disk or a semiconductor memory and is used as an operation memory for temporarily holding various information generated in the stage where the processing circuit 121 processes information, or as a database for storing information regarding previous purchases made by a consumer. The display 126 displays information, etc. and is provided with an image display device such as a CRT, a liquid crystal display or the like. Programs which are stored in the program memory 122 and are to be executed by the CPU in the processing circuit 121 are provided by a memory medium such as ROM, CD-ROM or the like, or they may also be provided via a transmission medium such as a communications line or the like.

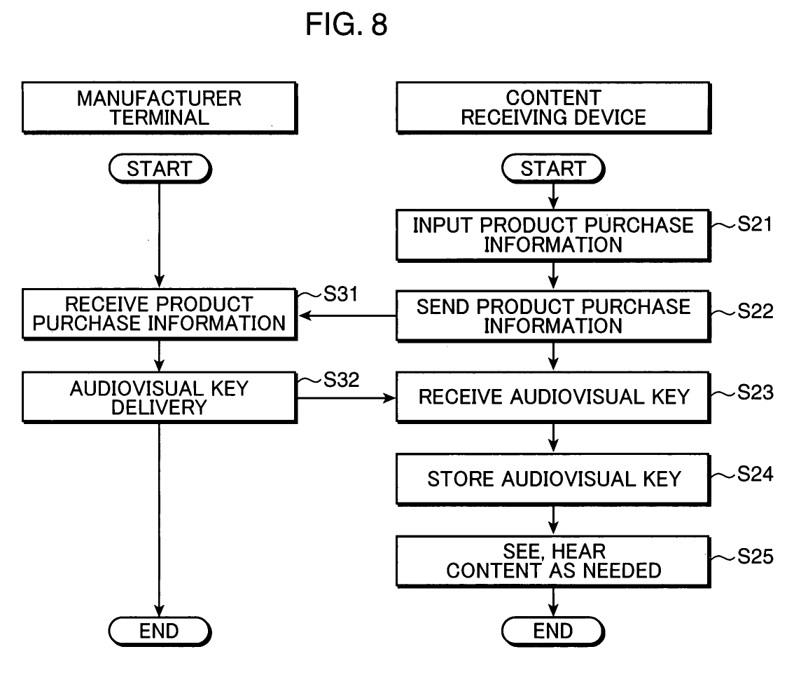

Each type of function (or means) carried out by the manufacturer terminal 30 and each type of function (or means) carried out by the content receiving device 21, 22 or 23 in the process of interchanging information with the manufacturer terminal 30 are shown as steps of the following flow charts, instead of representing a block diagram based on such functions. In the example shown in FIG. 8, the content receiving devices 21, 22 and 23 execute a product purchase information input function (means) corresponding to step S21 and a product purchase information transmission function (means) corresponding to step S22, and the manufacturer terminal 30 executes a product purchase information receiving function (means) corresponding to a step S31 and an audiovisual key delivery function (means) corresponding to a step S32. Each function (means) carries out the operation of the corresponding process (step). It is operable to provide the content receiving devices 21, 22 and 23 with the hardware configuration as illustrated in FIG. 4 in order to carry out each function (or each means) defined as step of the flow chart of FIG. 8, and provided in the program memory 82 of the content receiving device 21, 22 or 23 to accomplish each function (each means).

FIGS. 8-10 are flow charts showing three different examples of processing sequence which are carried out in the content distribution system 101 according to the first embodiment, and which the manufacturer terminal 30 and the content receiving device 21, 22 or 23 execute by interchanging information between the manufacturer terminal 30 and each of the content receiving device 21, 22 and 23 via the communications line 6. In the example shown in FIG. 8, at first, the input section 84 (see FIG. 4) of the content receiving device 21, 22 or 23 allows an input of the product purchase information by the consumer 1. (S21)

Next, the processing circuit 81 of the content receiving devices 21, 22 or 23 causes the communication section 83 to send the inputted product purchase information to the manufacturer terminal 30 via the communications line 6 (S22). The communication section 123 (see FIG. 7) of the manufacturer terminal 30 receives the product purchase information sent from the content receiving device 21, 22 or 23 (S31). Next, the processing circuit 121 of the manufacturer terminal 30 reads the audiovisual key stored in the memory 125 and causes the communication section 123 to deliver the audiovisual key to the corresponding content receiving device 21, 22 or 23 via the communications line 6 (S32). The communication section 83 of the content receiving section 21, 22 or 23 that is the target of such delivery receives the audiovisual key (S23).

Next, the processing circuit 81 of the content receiving device 21, 22 or 23 once stores the received audiovisual key in memory 85 (S24). After that, since the audience 1 causes the input section 84 to send the stored audiovisual key to the information distribution device 11, 12 or 13, the processing circuit 81 of the content receiving device 21, 22 or 23 reads the stored audiovisual key from the memory 85, further causes the communication section 83 to send the read audiovisual key to the information distribution device 11, 12 or 13 and finally causes the display 86 to display the decrypted content sent by the information distribution devices 11, 12 or 13 (S25). Consequently, the audience 1 can see and hear the content.

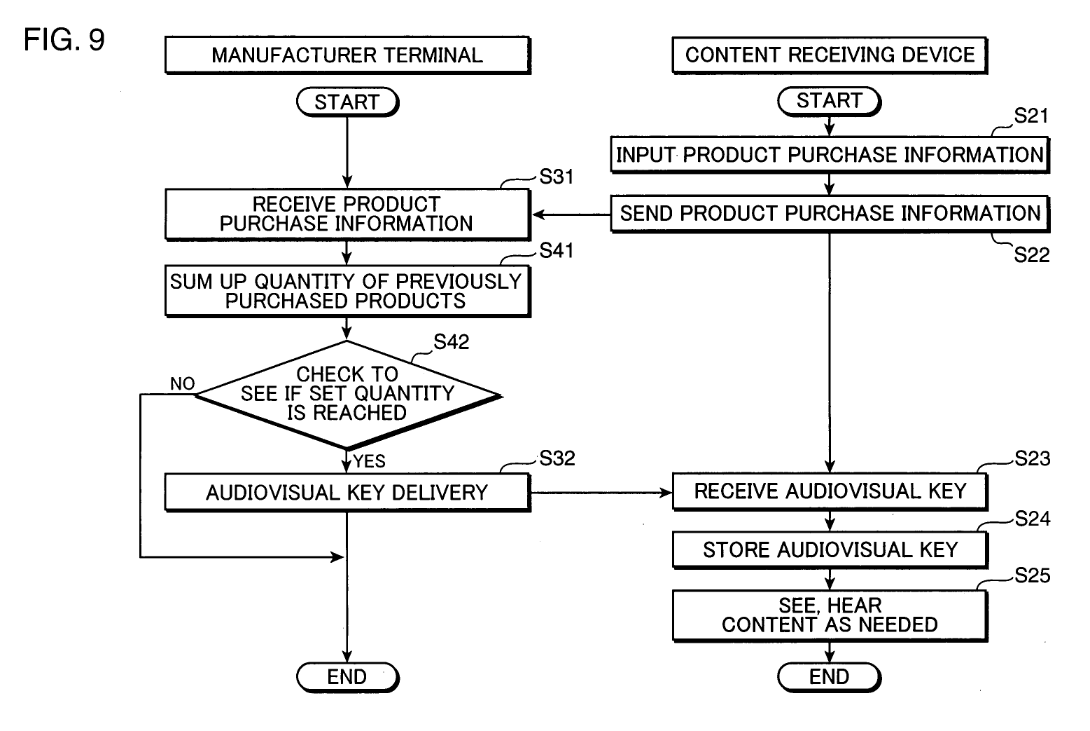

The operation of step S25 corresponds to the operations of steps S1 to S3 shown in FIG. 6. However, in step S1, instead of having the audience 1 input an audiovisual key, the input section 84 is caused to send the audiovisual key stored in the memory 85 to the information distribution device 11, 12 or 13, as described above. In other words, in step S1, the input section 84 is subject to an operation by the audience 1 that enables use of the audiovisual key stored in memory 85. In step S2, the transmission section 94 reads the audiovisual key stored in memory 85 and sends the read audiovisual key to the information distribution device 11, 12 or 13. With regard to the content selection, manufacturers 31 and 32 can define the type, number of viewable contents and the viewing time thereof in the audiovisual key, according to the price and quantity of products purchased by the consumer 1. In this case, the audience 1 (=consumer 1) can freely select a content within the region set by the delivered audiovisual key. Also, the manufacturers 31 and 32 can segmentalize the conditions for audience 1 to view the content and at the same time, the audience 1 can have an increased degree of freedom to select the products to be purchased in order to view the content. FIG. 9 is a flow chart showing the sequence of processes carried out in the example of the content distribution system101 built as described above, between the manufacturer terminal 30 and each of the content receiving devices 21, 22 and 23. The steps described with reference to this flow chart which are identical to those described with reference to other flow charts are assigned with identical reference numerals, and detailed description thereof is omitted.

The sequence shown in FIG. 9 is different from that shown in FIG. 8 in that after the manufacturer terminal 30 has received the product purchase information (S31), the operations of step S41 and step S42 are carried out. More specifically, after step S31 has been completed, the manufacturer terminal 30 sums up the quantity of products purchased in the past by the consumer 1 who is the audience 1 of the content receiving devices 21, 22 or 23 which sent the product purchase information (step S41). The quantity of the products purchased in the past is stored for each consumer 1 as a database in the memory 125. The processing circuit 121 carries out the above summing up by adding the quantity of products purchased by the consumer 1 newly causing the product purchase information to the quantity of products purchased in the past using the database as the reference. Moreover, the processing circuit 121 coordinates the newly summed up quantity with the consumer 1 and records the information in the memory 125. Accordingly, the database accumulated in the memory 125 is updated for each consumer 1.

Next, the processing circuit 121 determines whether the quantity of products newly summed up reaches a quantity corresponding to a predetermined threshold value (S42). The threshold value is for instance stored in advance in the program memory 122 as a part of the program. If the quantity of the summed up products does not reach the threshold value (NO in step S42), the manufacturer terminal 30 terminates the processing. On the one hand, if the quantity of the summed up products reaches the threshold value (YES in step S42), the processing circuit reads the audiovisual key stored in the memory 125 and causes the communication section 123 to deliver the audiovisual key to the corresponding content receiving device 21, 22 or 23 via the communications line 6 (S32).

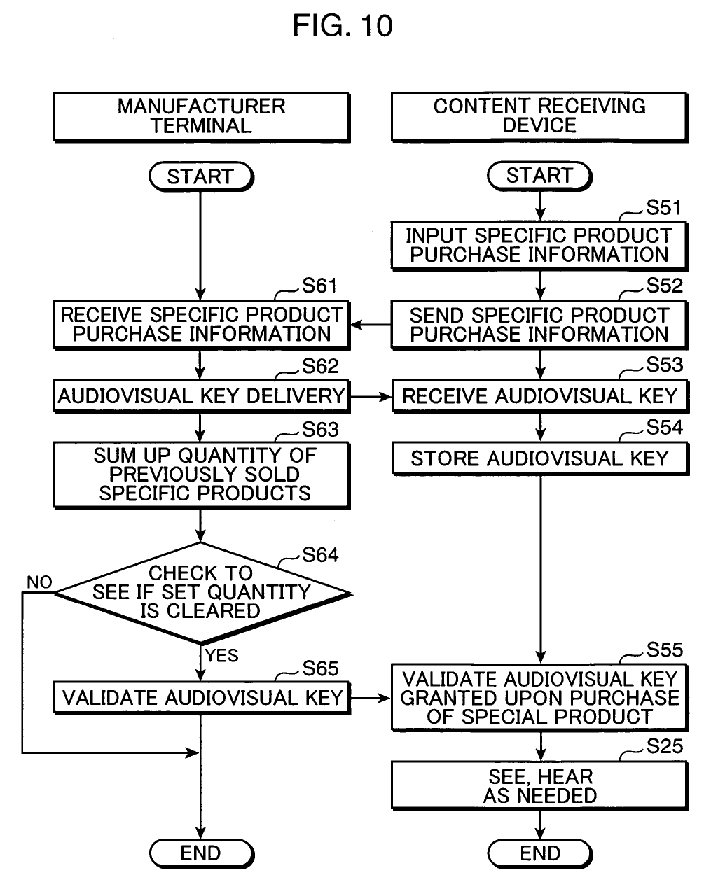

In the content distribution system 101, it is possible to correlate a specific product to a specific content (for instance, Olympic games commemorative products and Olympic event broadcasting) and to set the delivered audiovisual key to become usable when the overall price or quantity of the purchased products correlated with a certain audiovisual key exceeds a certain value. FIG. 10 is a flow chart showing a processing sequence carried out between each of the content receiving devices 21, 22 and 23 and the manufacturer terminal 30 in the content distribution system 101 having the configuration described above. In the processing sequence described with FIG. 10, at first, the input section 84 (refer to FIG. 4) of the content receiving devices 21, 22 or 23 receives the specific product purchase information inputted by the consumer 1 (S51).

Next, the processing circuit 81 of the content receiving device 21, 22 or 23 causes the communication section 83 to send the inputted specific product purchase information to the manufacturer terminal 30 via the communications line 6 (S52). The communication section 123 of the manufacturer terminal 30 (refer to FIG. 7) receives the specific product purchase information sent from the content receiving device 21, 22 or 23 (S61). In the next step, the processing circuit 121 of the manufacturer terminal 30 reads the audiovisual key stored in the memory 125 and causes the communication section 123 to deliver the audiovisual key to the corresponding content receiving device 21, 22 or 23 via the communications line 6 (S62). The communication section 83 of the content receiving device 21, 22 or 23 that is the target of such delivery receives the audiovisual key (S53).

The processing circuit 81 of the content receiving devices 21, 22 or 23 once stores the received audiovisual key in memory 85 (S54). In parallel with this, after step S62 has been completed, the manufacturer terminal 30 sums up the quantity of specific products sold in the past to consumer 1 who is the audience 1 of the content receiving device 21, 22 or 23 that sent the specific product purchase information (step S63). The quantity of specific products sold in the past is stored for each consumer 1 as a database in the memory 125. The processing circuit 121 carries out the above summing up by adding the quantity of products sold to the consumer 1 newly causing the specific product purchase information to the quantity of products sold in the past using the database as the reference. Moreover, the processing circuit 121 coordinates the newly summed up quantity with the consumer 1 and records the information in the memory 125. Accordingly, the database accumulated in the memory 125 is updated for each consumer 1.

Next, the processing circuit 121 determines whether the quantity of specific products newly summed up reaches a quantity corresponding to a predetermined threshold value (S64). The threshold value is for instance stored in advance in the program memory 122 as a part of the program. If the quantity of the summed up products does not reach the threshold value (NO in step S64), the manufacturer terminal 30 terminates the processing. On the one hand, if the quantity of the summed up products reaches the threshold value (YES in step S64), the processing circuit 121 reads the validation information stored in the memory 125 in advance which is information for validating the audiovisual key already sent and causes the communication section 123 to send the information to the corresponding content receiving device 21, 22 or 23 via the communications line 6 (S65).

After the communication section 83 of the content receiving device 21, 22 or 23 receives the validation information, the processing circuit 81 reads the audiovisual key already stored in the memory 85 and validates the audiovisual key by writing, for instance, the validation information to the audiovisual key, in other words, makes it operational. Then, the processing circuit 81 stores the validated audiovisual key in the memory 85 (S55). Further, by carrying out the same operation as that of step S25 described with reference to FIG. 8, the audience 1 can thus see and hear the above content at a desired time. Consequently, when the quantity of sold products of manufacturers 31 or 32 has exceeded a certain value, the audiovisual key delivered in advance at the time of product purchasing becomes operational, thus enabling the manufacturers 31 or 32 to distribute their content while stimulating the consumer 1 to buy.

FIG. 9 and FIG. 10 show examples where the sequence of audiovisual key communication, etc. between the manufacturer terminal 30 and the content receiving device 21, 22 or 23 is carried out automatically, but the sequence can also be carried out manually between the consumer 1 and the manufacturer 31 or 32 or the delivery agent's salespeople, etc.

In the sequence described with reference to FIGS. 8 to 10, the communications line 6 functioning as a medium for the interchanges between the content receiving device 21, 22 or 23 and the manufacturer terminal 30 may be provided separately from the communications line 5 or may be routed through communications line 5. In the latter case, the interchanges between the content receiving device 21, 22 or 23 and the manufacture terminal 30 are carried out via the communications line 5 and the information distribution device 11, 12 or 13. Accordingly, in this case, the information distribution device 11, 12 or 13 transfer the information sent by the content receiving device 21, 22 or 23 to the manufacturer terminal 30 and transfer the information sent from the manufacturer terminal 30 to the content receiving device 21, 22 or 23.

Further, FIGS. 8 to 10 show the example where the terminal (called consumer terminal) that carries out communications with the manufacturer terminal is the terminal on the content receiving device 21, 22 or 23. However, it may be appreciated to separately provide a content receiving device 21, 22 or 23 that carries out communication with the information distribution device 11, 12 or 13 and a consumer terminal that carries out communication with the manufacturer terminal 30 as far as the both are owned by the same audience 1. In this case, the audiovisual key sent to the consumer terminal from the manufacturer terminal 30 is inputted or transmitted to the content receiving device 21, 22 or 23 by the way of online or offline.

### SECOND EMBODIMENT

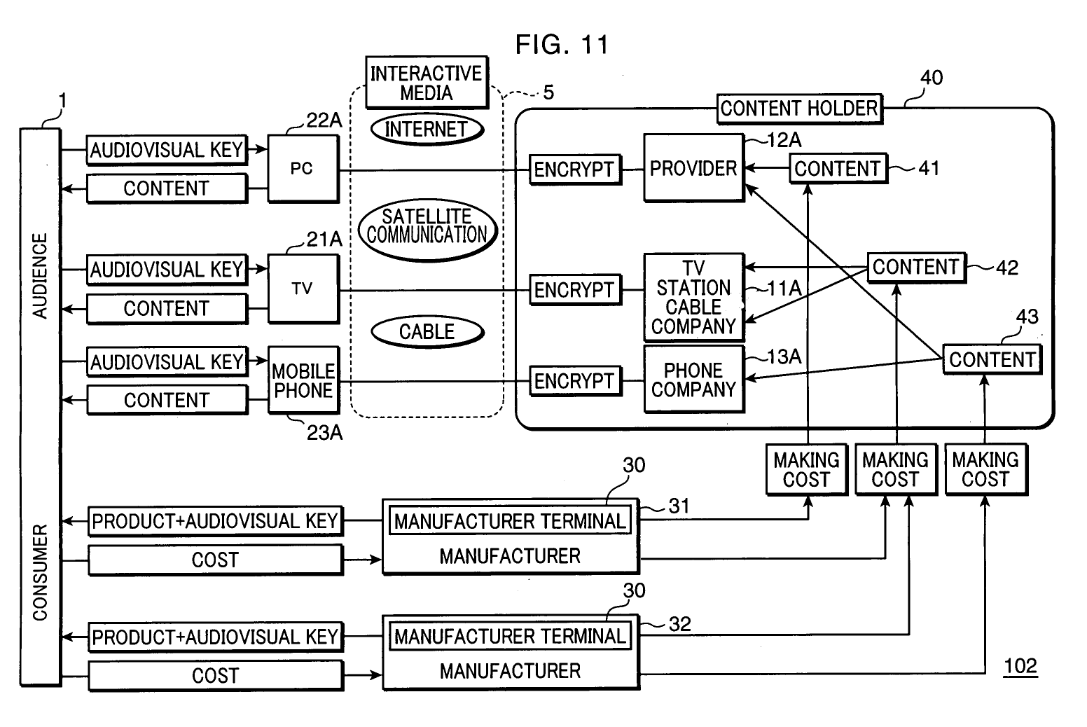

In the content distribution system 101 according to the first embodiment, the decryption section 73 is provided on the information distribution devices 11, 12 and 13. However, the identical effect can be achieved by providing a decryption section on the content receiving devices 21, 22 or 23. FIG. 11 is a block diagram showing a content distribution system having the configuration as described above. The content distribution system 102 is different from the content distribution system 101 according to the first embodiment described with reference to FIG. 1 in that the information distribution devices 11, 12 and 13 are replaced with information distribution devices 11A, 12A and 13A and the content receiving devices 21, 22 and 23 are replaced with content receiving devices 21A, 22A and 23A, respectively.

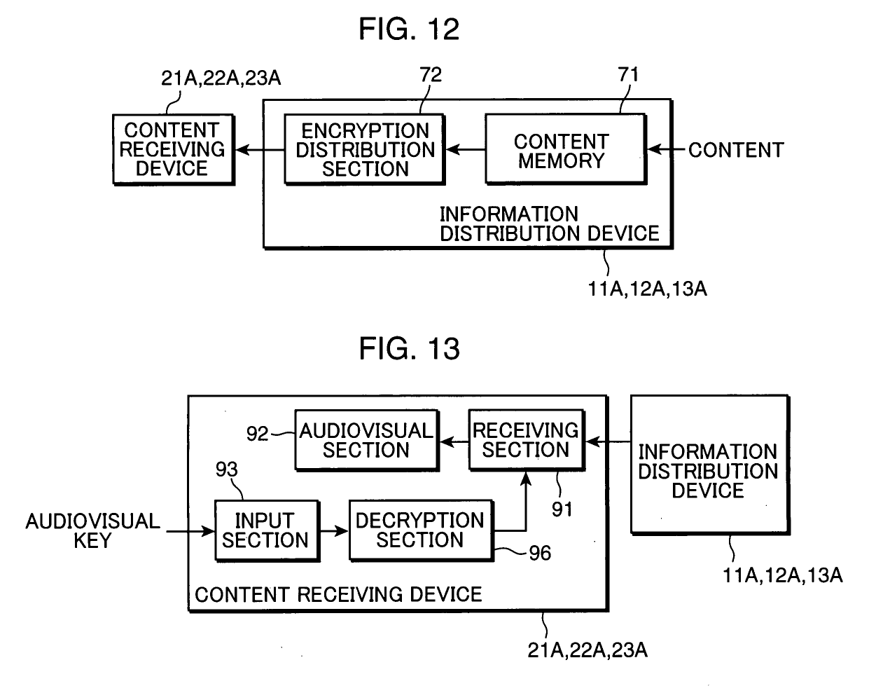

FIG. 12 is a block diagram showing a configuration based on the main functions of the information distribution devices 11A, 12A or 13A. The hardware configuration of the information distribution devices 11A, 12A and 13A is the same as that of FIG. 2. As shown in FIG. 12, the information distribution devices 11A, 12B and 13A each have a content memory 71 and an encryption distribution section 72, and are different from the information distribution devices 11, 12 and 13 in that they do not need the decryption section 73 shown in FIG. 3. The encryption distribution section 72 distributes the content stored in the content memory 71 to the content receiving devices 21A, 22A and 23A without carrying out any decryption.

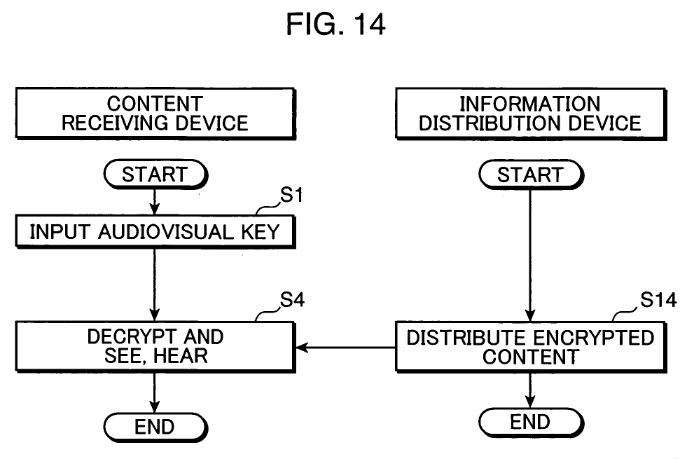

FIG. 13 is a block diagram showing a configuration based on the main functions of the information distribution device 21A, 22A or 23A. The content receiving devices 21A, 22A and 23A each have a receiving section 91, an audiovisual section 92, an input section 93 and a decryption section 96, and are different from the content receiving devices 21, 22 and 23 in that the transmission section 94 illustrated in FIG. 5 is not necessary. When the input section 93 receives an audiovisual key inputted by an audience 1, the decryption section 96 decrypts the content received by the receiving section 91. As a result, the audiovisual section 92 can reproduce decrypted content in the same way as the audiovisual section 92 shown in FIG. 5.

Consequently, in the content distribution system 102, content distributed by the information distribution devices 11A, 12A and 13A can be seen and heard when the audiovisual key is used by the audience 1. However, the content distribution system 101 according to the first embodiment wherein the information distribution devices 11, 12 and 13 have the decryption section 73 is superior in that there is no danger that ill-intentioned users (audience 1) may alter the functions of the device at hand and view content illegally. In other words, from the point of view of security, it is preferable to provide a decryption section on the information distribution devices 11, 12 and 13.

FIG. 14 is a flow chart describing the operation of the content distribution system 102 according to the second embodiment. In the content distribution system 102, the consumer 1 or the audience 1 first inputs the received audiovisual key to the input section 93 of the content receiving device 21A, 22A or 23A (S1). In other words, the input section 93 receives an audiovisual key inputted by the audience 1. In the information distribution device 11A, 12A or 13A, before that, the encryption distribution section 72 may initiate distribution of the encrypted content according to a program or in response to an audiovisual request from the content receiving devices 21A, 22A and 23A (S14).

The receiving section 91 of the content receiving device 21A, 22A or 23A receives the encrypted content distributed by the information distribution device 11A, 12A or 13A. The decryption section 96 decrypts the received content by using the audiovisual key inputted in the input section 93 as a decryption key. Moreover, the audiovisual section 92 reproduces the decrypted content (S4). As a result, the audience 1 can view or listen to content such as image, music by means of the display screen or speaker of the display 86. The encryption distribution section 72 may initiate the distribution of the content (S14) after the input section 93 of the content receiving device 21A, 22A or 23A has accepted an input of the audiovisual key (S1).

In the content distribution system 102 according to this embodiment, manufacturers 31 and 32 or product distributors, etc. have manufacturer terminals 30, and as shown in FIGS. 8 to 10, information interchange between the manufacturer terminal 30 and each of the content receiving devices 21, 22 or 23 can be carried out via the communication line 6. In this case, the operation of step S25 described with FIGS. 8 to 10 corresponds to that of steps S1 and S4 shown in FIG. 14. However, in step S1, the audience 1 causes, instead of inputting the audiovisual key, the input section 84 to make the audiovisual key stored in the memory 85 operational. In other words, in step S1, the input section 84 (or 93) is subject to the operation by the audience 1 that enables use of the audiovisual key stored in memory 85. In step S4, the receiving section 91 of the content receiving device 21A, 22A or 23A receives the encrypted content distributed by the information distribution devices 11A, 12A or 13A. After the input section 93 is subject to an operation by the audience 1 according to which the audiovisual key becomes usable, the decryption section 96 reads the audiovisual key stored in the memory 85, and by using the read audiovisual key as a decryption key, decrypts the received content. Moreover, the audiovisual section 92 reproduces the decrypted content (step S4).

### THIRD EMBODIMENT

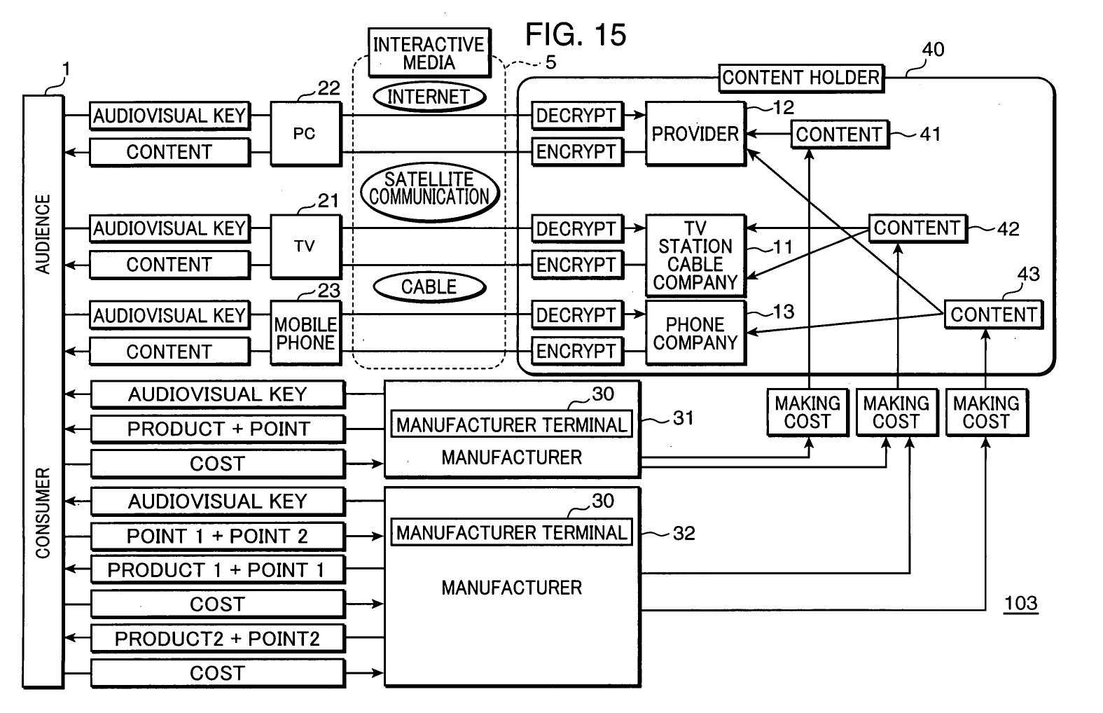

FIG. 15 is a block diagram showing a configuration of a content distribution system according to a third embodiment of the present invention. The content distribution system 103 is different from the content distribution system 101 of the first embodiment in that the manufacturers 31 and 32 do not deliver an audiovisual key for each product purchased by the consumer 1, but instead, points are set for each product correlated with the audiovisual key and the audiovisual key is delivered to the consumer 1 according to the acquired points.

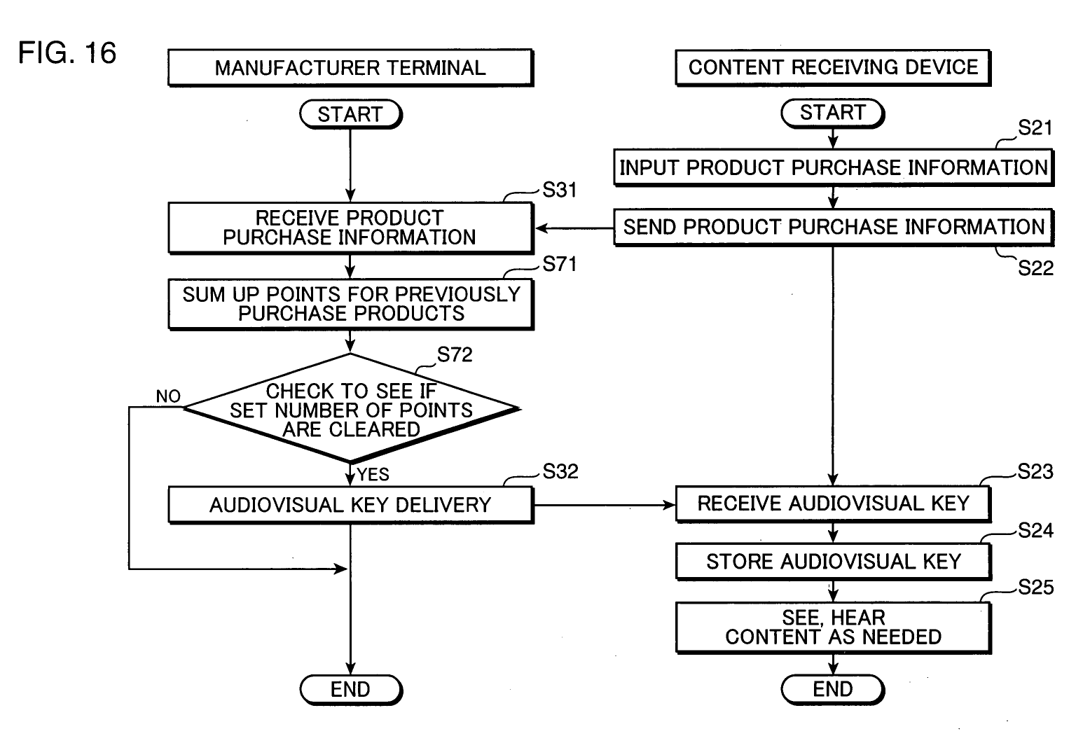

FIG. 16 is a flow chart showing an example of processing sequence executed by a manufacturer terminal 30 and a content receiving device 21, 22 or 23 in the content distribution system 103 interchanging information between the manufacturer terminal 30 and each of the content receiving devices 21, 22 and 23 via a communications line 6. The sequence described with reference to FIG. 16 is different from the sequence described with reference to FIG. 8 in that steps S71 and S72 are carried out after the manufacturer terminal 30 has received the product purchase information (S31). More specifically, after step S31, the manufacturer terminal 30 sums up (S71) the points for the products purchased in the past by the consumer 1 who is the audience 1 of the content receiving device 21, 22 or 23 that sent the product purchase information. The points of the products purchased in the past are stored for each consumer 1 as a database in the memory 125. The processing circuit 121 carries out the above summing up by adding the points of products purchased by the consumer 1 newly causing the product purchase information to the points in the past using the database as a reference. Moreover, the processing circuit 121 coordinates the newly summed up points with the consumer 1 and records the information in the memory 125. Accordingly, the database accumulated in the memory 125 is updated for each consumer 1.

Next, the processing circuit 121 determines whether the points of products newly summed up reach a certain number corresponding to a predetermined threshold value (S72). The threshold value is stored, for instance, in advance in the program memory 122 as a part of the program. If the points for the summed up products do not reach the threshold value (NO in step S72), the manufacturer terminal 30 terminates the processing. On the one hand, if the points for the summed up products reach the threshold value (YES in step S72), the processing circuit 121 reads the audiovisual key stored in the memory 125 and causes the communication section 123 to deliver the audiovisual key to the corresponding content receiving device 21, 22 or 23 via the communications line 6 (S32).

Consequently, because the manufacturer 31 or 32 in the system according to this embodiment delivers the audiovisual key to the consumer 1 when the points for the products purchased by the consumer 1 have reached a certain threshold value, the content distribution system 103, similarly to the example of the content distribution system 101 illustrated in FIG. 9, enables the manufacturers 31 and 32 to segmentalize the conditions for the audience 1 to view the content, and the audience 1 has an increased degree of freedom to select the products to be purchased in order to view the content. The manufacturers 31 and 32 can further segmentalize the conditions for the audience 1 to see and hear the content since the points can be allotted in other ways than the price of the products, such as giving additional points to specific products for sales promotion purposes, etc.

Also, the consumer 1 can further be stimulated to buy products by setting up the content distribution system 103 wherein in the case of a large number of points, the audience 1 can view foreign movies, for instance, before their release in that particular country by means of the display 92 of the content receiving device 21, 22 or 23 by sending the movies from the information distribution device 11, 12 or 13 to the content receiving device 21, 22 or 23 via the communications line 5.

FIG. 16 shows a sequence that communications between the manufacturer terminal 30 and each of the content receiving devices 21, 22 and 23 is carried out automatically. However, it may be appreciated to perform human communications between the consumer 1 and the manufacturer 31 or 32 or the delivery agent's salespeople, etc.

### FOURTH EMBODIMENT

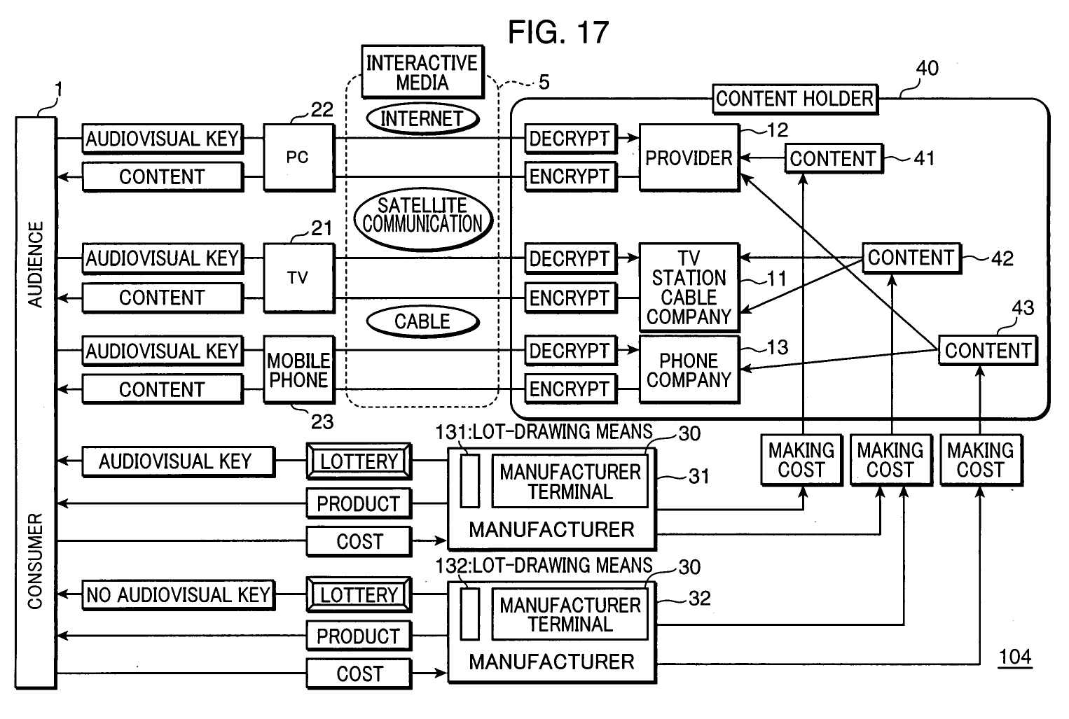

FIG. 17 is a block diagram showing a configuration of a content distribution system according to a fourth embodiment of the present invention. The content distribution system 104 is different from the content distribution system 101 of the first embodiment in that when a consumer 1 purchases products from a manufacturer 31 or 32 or from a sales agent, etc., the consumer 1 can draw lots using a lot-drawing means (lottery) 131 or 132 and the audiovisual key is delivered to the consumer according to the results of the lot drawing. Consequently, with the content distribution system 104, it is possible to amuse the consumer 1 upon his/her purchase of products thus stimulating the consumer 1 to buy products.

As the lot-drawing means 131, 132, various means may be used including the Japanese traditional garapon (a device where balls showing a hit and balls showing a miss are mixed together in a box which is then rotated around a rotational axis until any one of the balls comes out at random), or a scratch-off lottery ticket where a hit or a miss is revealed by scratching the surface of a seal, etc. In the case where the manufacturers 31 or 32 or the distributors, etc. have a manufacturer terminal 30, the manufacturer terminal 30 carries out the function of the lot-drawing means 131, 132, so that the lot-drawing means 131 and 132 become unnecessary. In other words, in FIG. 17, it is sufficient that the manufacturer 31 or 32 has either the lot-drawing means 131, 132 or the manufacturer terminal 30.

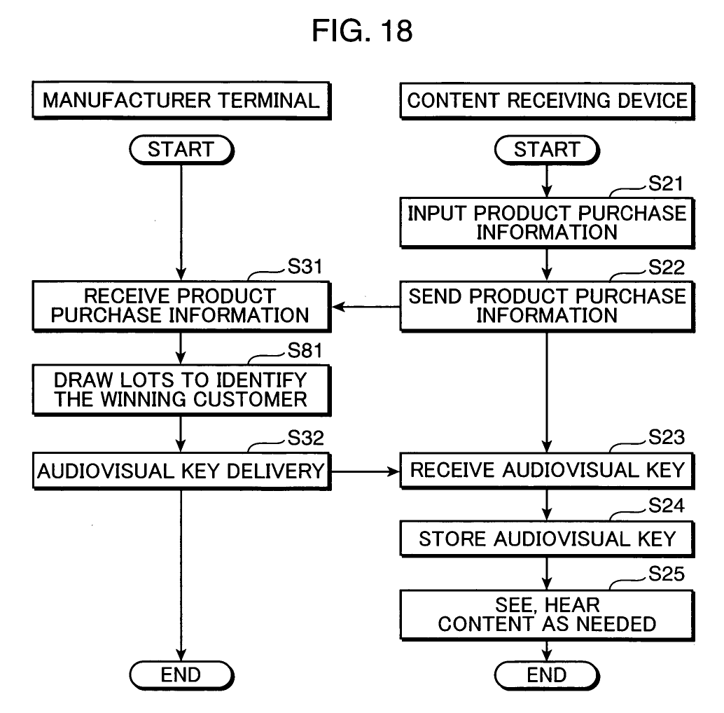

FIG. 18 is a flow chart showing an example of sequence of processing executed in the content distribution system 104 wherein the manufacturers 31, 32 or sale agents, etc., have the manufacturer terminal 30, and the manufacturer terminal 30 and the content receiving device 21, 22 or 23 perform according to the information interchanges between the manufacturer terminal 30 and each of the content receiving devices 21, 22 or 23 via the communications line 6. The sequence described with reference to FIG. 18 is different from the sequence described with reference to FIG. 8 in that step S81 is carried out after the manufacturer terminal 30 has received the product purchase information (S31). More specifically, after step S31, the processing circuit 121 of the manufacturer terminal 30 executes lottery drawing and determines whether the consumer 1 that sent the product purchase information has won (S81). Alternatively, the processing circuit 121 may identify the winner (or winners) from a plurality (generally) of consumers 1 that have sent the product purchase information in advance by holding the lottery in step S81. The processing circuit 121 executes the lottery by using random numbers, for instance and elects the winner with a given probability.

Then, the processing circuit 121 reads the audiovisual key stored in the memory 125 and causes the communication section 123 to deliver the audiovisual key to the content receiving device 21, 22 or 23 corresponding to the consumer 1 who won the lottery via the communications line 6 (S32).

### FIFTH EMBODIMENT

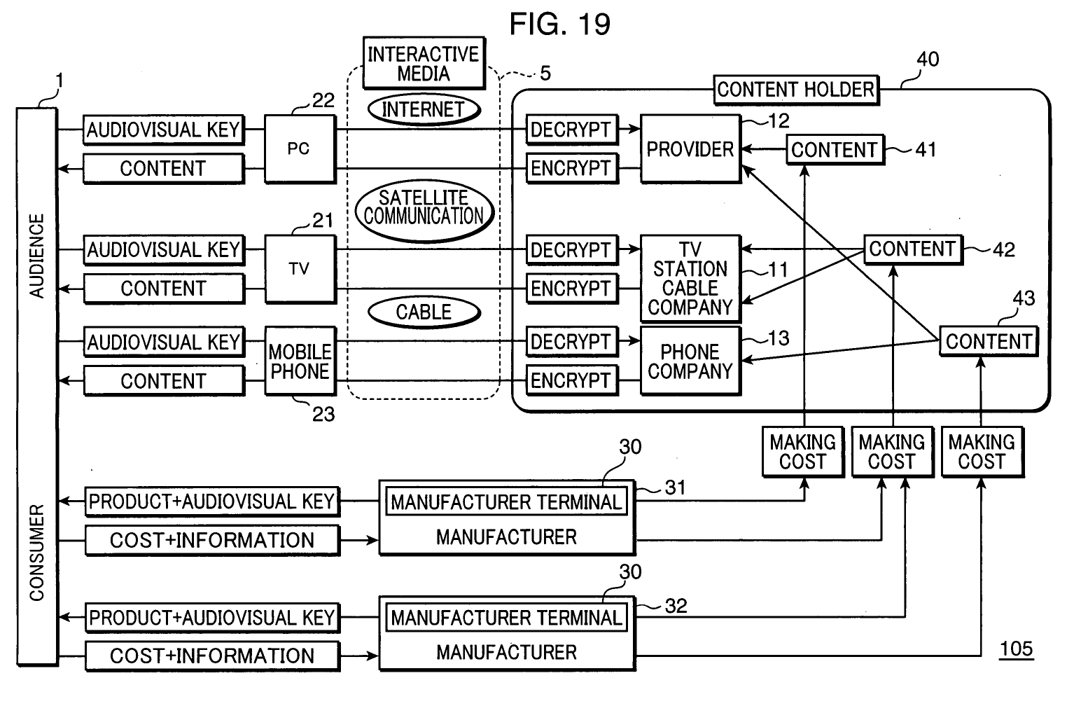

FIG. 19 is a block diagram showing a configuration of a content distribution system according to a fifth embodiment of the present invention. The content distribution system 105 is different from the content distribution system 101 described in the first embodiment in that when a consumer 1 effects payment for the product to a manufacturer 31 or 32, or after that (in other words, incident with payment), he/she sends information regarding the product, such as his/her expectations related to the product, impressions after using the product, the recommended price or information regarding the consumer 1 such as consumer's age, sex, purchasing motive, etc. and is thereafter given an audiovisual key according to the sent information.

Consequently, in the content distribution system 105, based on the information received from the consumer 1, the manufacturers 31 and 32 can understand the trends of consumers 1 more easily and can obtain important guidance as far as development of future products is concerned. Also, the manufacturers 31 and 32 can expand the scope of viewable content and the viewing time by use of an audiovisual key delivered at the time of product purchase and can further provide added value to the consumer by delivering a new audiovisual key that enables viewing of different content. Therefore, an incentive is created for consumer 1 regarding provision of information and the manufacturers 31 and 32 can obtain abundant useful information.

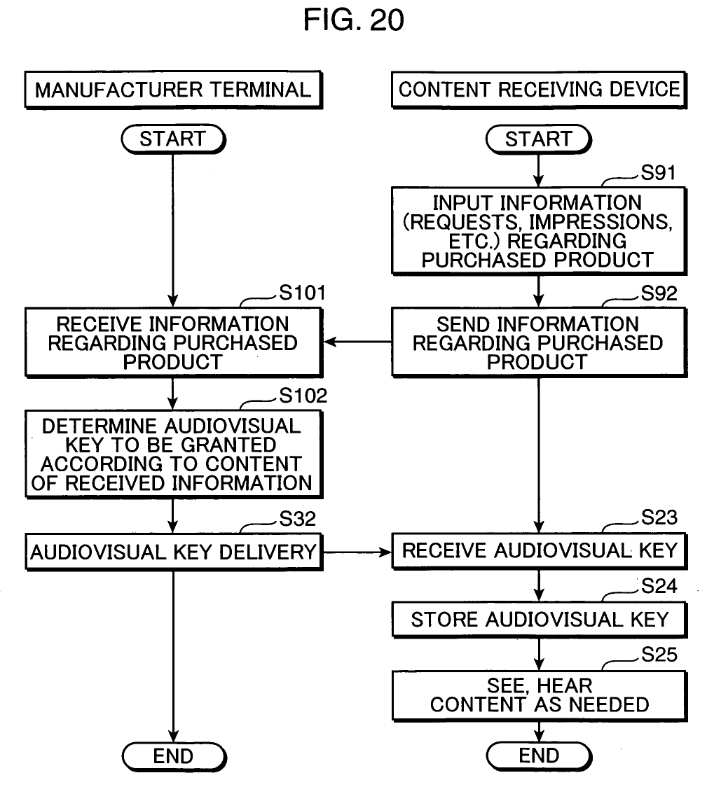

FIG. 20 is a flow chart showing an example of sequence of processing executed in the content distribution system 105 wherein the manufacturers 31, 32 or sale agents, etc., have a manufacturer terminal 30, and the manufacturer terminal 30 and the content receiving device 21, 22 or 23 perform according to the information communications between the manufacturer terminal 30 and each of the content receiving devices 21, 22 and 23 via the communications line 6. In the sequence described with reference to FIG. 20, the input section 84 (see FIG. 4) of the content receiving device 21, 22 or 23 first receives an input regarding the product purchased by the consumer 1 (S91).

Next, the processing circuit 81 of the content receiving device 21, 22 or 23 causes the communication section 83 to send the inputted information regarding the purchased product to manufacturer terminal 30 via the communications line 6 (S92). The communication section 123 of the manufacturer terminal 30 (see FIG. 7) receives the information regarding the purchased product sent from the content receiving device 21, 22 or 23 (S101). Next, based on the content of the information regarding the purchased product, the processing circuit 121 of the manufacturer terminal 30 determines an appropriate key among a plurality of audiovisual keys stored in memory 125 in advance and reads the appropriate audiovisual key from the memory 125 (S102). Next, the processing circuit 121 causes the communication section 123 to deliver the audiovisual key to the corresponding content receiving device 21, 22 or 23 via the communications line 6 (S32). The subsequent operations (S23 to S25) in the content receiving device 21, 22 or 23 which is the target of the audiovisual key distribution are carried out in the same way as the corresponding operations shown in FIG. 8.

### SIXTH EMBODIMENT

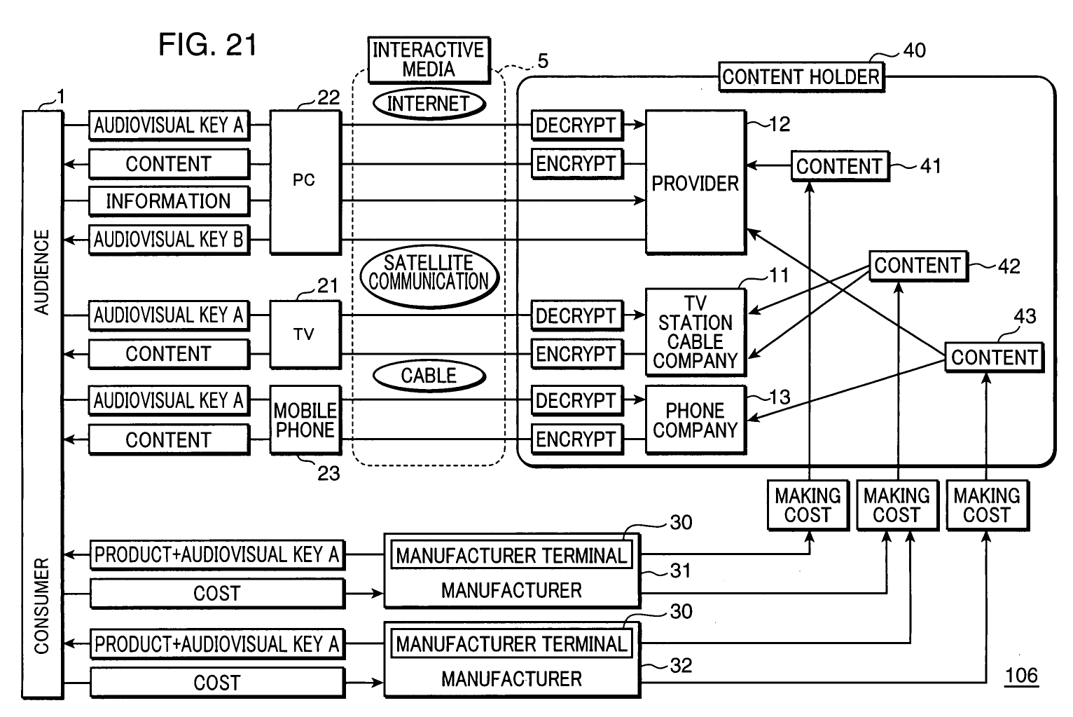

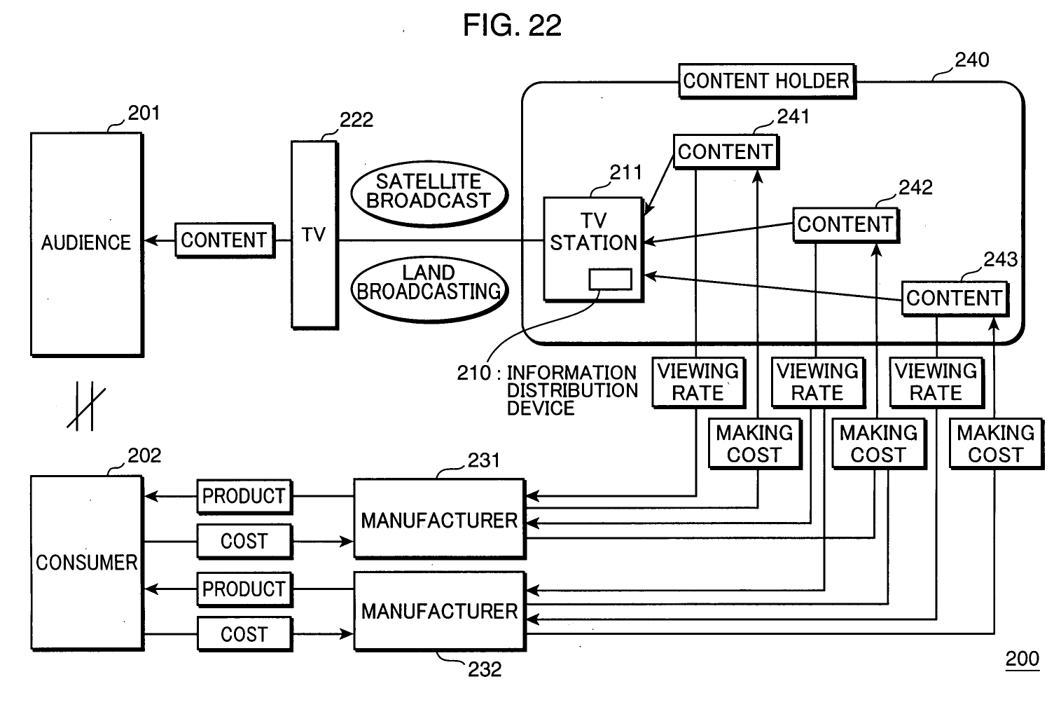

FIG. 21 is a block diagram that shows a configuration of a content distribution system according to a sixth embodiment of the present invention. The content distribution system 106 is different from the content distribution system 101 of the first embodiment in that an audience 1 sends information including impressions regarding the viewed contents and expectations for content in the future to an information distribution device 11, 12 or 13 owned by a content holder 40 (in FIG. 21, the audience 1 sends information to the information distribution device 12 via a content receiving device 22, but the same effect is obtained in the case where the information is sent to the information distribution device 11 or 13), and an audiovisual key (shown as ‘audiovisual key B’) is delivered from information distribution devices 11, 12 or 13 of the content holder 40 in accordance with the sent information, the audiovisual key B being different from the common audiovisual key (shown as ‘audiovisual key A’) delivered by manufacturer 31 or 32.

Consequently, in the content distribution system 106, based on the information received from the consumer 1, the content holder 40 can easily understand preferences of the consumer 1, and can obtain important guidance as far as making of future content is concerned. Also, the audience 1 can expand the scope of viewable content, the viewing time, and allow viewing of another contents by use of the audiovisual key A delivered at the time of product purchase. The expanding of content scope includes, for instance, a way of allowing not only viewing of content of a first story in a series program including a plurality of stories, but also viewing of contents of some or all of the remaining stories. Expanding of viewing time includes, for instance, a way of allowing not only viewing of content of a first half part of a movie but also viewing of contents of both first half part and second half part thereof. Viewing of another content includes, for instance, a way of allowing not only viewing of a movie with a certain title but also a movie with a different title.

### OTHER EMBODIMENTS

In the foregoing examples, the contents to be distributed by the content holder 40 are contents of programs which are to be broadcast by terrestrial televisions and carries no commercial messages. However, it may be appreciated that the contents to be distributed includes contents carrying commercial messages directed to the audience 1 who is to be sent the audiovisual key. Based on information embedded in the audiovisual key, the information distribution devices 11, 12 and 13 can determine that the audience 1 who has sent the audiovisual key had purchased as a consumer 1 what product of which of the manufacturers 31 and 32. Accordingly, the information distribution devices 11, 12 and 13 can select commercial messages having a particularly high advertising effect, add them to the content, and distributes them to the audience 1 who has sent the audiovisual key. For instance, it may be possible to selectively add to the content distributed to the audience 1 who has purchased a video cassette recorder which is a product made by the manufacturer 31, commercial messages for products other than the video cassette recorder made by the manufacturer 31 or for products which are associated with the video cassette recorder. Manufacturer 31 can thereby obtain a higher advertising effect regarding its own products.

Various Aspects of the Invention

The invention is not limited in any way to the various embodiments described above, but it can also construed as having the following aspects.

Specifically, a first aspect of the invention provides a content distribution system having an information distribution device, a manufacturer terminal and a content receiving device which are connectable with one another via a communications line, wherein the information distribution device has an encryption distribution means for encrypting and distributing a content, the content receiving device has a product purchase information input means for accepting an input of product purchase information and a product purchase information sending means for sending the received product purchase information to the manufacturer terminal, the manufacturer terminal has a product purchase information receiving means for receiving the sent product purchase information and a decryption key delivery means which includes a first memory for storing a decryption key and which, upon receiving the product purchase information, reads the decryption key from the first memory and delivers it to the content receiving device, wherein the content receiving device has a decryption key receiving means for receiving the decryption key delivered by the manufacturer terminal, a decryption key storage means which includes a second memory and which stores the received decryption key in the second memory, an input means for accepting an operation which enables use of the decryption key stored in the second memory, and a decryption key sending means which, upon receiving the operation from the input means, reads the decryption key from the second memory and sends it to the information distribution device, wherein the information distribution device further has a decryption means which receives the decryption key sent from the decryption key sending means and uses the received decryption key to decrypt the content distributed by the encryption distribution means, and the content receiving device further includes a content receiving means for receiving the content sent by the encryption distribution means and an audiovisual means for reproducing the content received by the content receiving means.

A second aspect of the invention provides a content distribution system having an information distribution device, a manufacturer terminal and a content receiving device which are connectable with one another via a communications line, wherein the information distribution device has an encryption distribution means for encrypting and distributing a content, the content receiving device has a product purchase information input means for accepting an input of product purchase information and a product purchase information sending means for sending the received product purchase information to the manufacturer terminal, the manufacturer terminal has a product purchase information receiving means for receiving the sent product purchase information and a decryption key delivery means which includes a first memory for storing a decryption key and which, upon receiving the product purchase information, reads the decryption key from the first memory and delivers it to the content receiving device, wherein the content receiving device further has a content receiving means for receiving the content sent from the encryption distribution means, a decryption key receiving means for receiving the decryption key delivered by the manufacturer terminal, a decryption key storage means which includes a second memory and which stores the received decryption key in the second memory, an input means for accepting an operation which enables use of the decryption key stored in the second memory, a decryption means which, upon receiving the operation from the input means, reads the decryption key from the second memory and uses it to decrypt the content received by the content receiving device and an audiovisual means for reproducing the content decrypted by the decryption means.

A third aspect of the invention provides a content distribution system having an information distribution device and a content receiving device which are connectable with each other via a communications line, a consumer terminal and a manufacturer terminal which are connectable with each other via a communications line, wherein the information distribution device has an encryption distribution means for encrypting and distributing a content, the consumer terminal has a product purchase information input means for accepting an input of product purchase information and a product purchase information sending means for sending the received product purchase information to the manufacturer terminal, the manufacturer terminal has a product purchase information receiving means for receiving the sent product purchase information and a decryption key delivery means which includes a first memory for storing a decryption key and which, upon receiving the product purchase information, reads the decryption key from the first memory and delivers it to the consumer terminal, wherein the consumer terminal further has a decryption key receiving means for receiving the decryption key delivered by the manufacturer terminal, wherein the content receiving device has an input means for accepting an input of the decryption key received by the consumer terminal, a decryption key sending means which, upon receiving the input from the input means, sends the decryption key to the information distribution device, wherein the information distribution device further includes a decryption means which receives the decryption key sent by the decryption key sending means and uses the received decryption key to decrypt the content distributed by the encryption distribution means, the content receiving device further including a content receiving means for receiving the content sent by the encryption distribution means and an audiovisual means for reproducing the content received by the content receiving means.

A fourth aspect of the invention provides a content distribution system having an information distribution device and a content receiving device which are connectable with each other via a communications line, a consumer terminal and a manufacturer terminal which are connectable with each other via a communications line, wherein the information distribution device has an encryption distribution means for encrypting and distributing a content, the consumer terminal has a product purchase information input means for accepting an input of product purchase information and a product purchase information sending means for sending the received product purchase information to the manufacturer terminal, the manufacturer terminal has a product purchase information receiving means for receiving the sent product purchase information and a decryption key delivery means which includes a first memory for storing a decryption key and which, upon receiving the product purchase information, reads the decryption key from the first memory and delivers it to the consumer terminal, wherein the consumer terminal further has decryption key receiving means for receiving the decryption key delivered by the manufacturer terminal, wherein the content receiving device has a content receiving means for receiving the content sent by the encryption distribution means, an input means for accepting an input of the decryption key received by the consumer terminal, a decryption means which upon receiving the input from the input means uses the decryption key to decrypt the content received by the content receiving means, and an audiovisual means for reproducing the content decrypted by the decryption means.

A fifth aspect of the invention provides a content distribution system comprising an information distribution device provided with an encryption distribution means for encrypting and distributing via interactive media content created by a content holder using a budget provided by a single manufacturer or a plurality of manufacturers and a decryption means which receives a decryption key given owing to purchase of a product of the manufacturer and decrypts the content distributed by the encryption distribution means, and a content receiving device provided with an input means for inputting the decryption key given owing to purchase of the manufacturer's product, a sending means which, after the decryption key is inputted by the input means sends the inputted decryption key to the information distribution device, a receiving means for receiving the content sent by the information distribution device and an audiovisual means for reproducing the content received by the receiving means.

A sixth aspect of the invention provides a content distribution system containing an information distribution device provided with an encryption distribution means for encrypting and distributing a content created by a content holder using a budget provided by a single manufacturer or a plurality of manufacturers and a content receiving device provided with a receiving means for receiving the content sent from the information distribution device, an input means for inputting the decryption key given owing to purchase of the manufacturer's product, a decryption means which after the decryption key is inputted from the input means, decrypts the content received by the receiving means and an audiovisual means for reproducing the content decrypted by the decryption means.

In a content distribution system according to any one of the first to sixth aspects of the invention, an information distribution device enables viewing of the content by a customer that purchased manufacturer's products, so that the correlation between content and user becomes stronger and manufacturer's investment efficiency in content increases.

A seventh aspect of the invention provides a content distribution system according to any one of the first to sixth aspects configured so that the decryption key is given in accordance with the price of products purchased from the single or the plurality of manufacturers or the quantity of the purchased products.

According to the seventh aspect of the invention, the decryption key is given in accordance with the price of products purchased from a single or a plurality of manufacturers or the quantity of the purchased products so that the manufacturers can segmentalize the conditions under which a user views the content, and the user can have a higher degree of freedom in selecting the product to be purchased in order to view the content.

An eighth aspect of the invention provides a content distribution system according to any one of the first to sixth aspects configured so that the decryption key is given in accordance with the points, which points are given in accordance with the price of products purchased from the single manufacturer or the plurality of manufacturers or on the quantity of the purchased products.

According to the eighth aspect of the invention, the decryption key is given in accordance with thepoints, which points are allotted in accordance with the price of products purchased from the single manufacturer or the plurality of manufacturers or on the quantity of the purchased products so that the manufacturer can segmentalize the conditions under which a user views a content and the user can have a higher degree of freedom in selecting the product to be purchased in order to view the content.

A ninth aspect of the invention provides a content distribution system according to any one of the first to sixth aspects wherein the decryption key is set according to each content or to a viewing time of the content.

According to the ninth aspect of the invention, a decryption key is set according to each content or to the viewing time of the content, so that the manufacturer can allow a user to view only the necessary content according to the product the user purchased.

A tenth aspect of the invention provides a content distribution system according to any one of the first to sixth aspects, wherein a decryption key given according to specific products purchased from the single manufacturer or the plurality of manufacturers can be used for decrypting the specific content.

According to the tenth aspect of the invention, the decryption key given according to the specific products purchased from the single manufacturer or the plurality of manufacturers can be used for decrypting the specific content, so that the manufacturer can permit a user to view only the necessary content according to the product the user purchased.

An eleventh aspect of the invention provides a content distribution system according to any one of the first to sixth aspects, wherein the decryption key given in advance owing to product purchasing becomes usable when the selling quantity for manufacturer's products exceeds a certain value.

According to the eleventh aspect of the invention, a decryption key given in advance owing to the product purchasing becomes usable when the selling quantity for manufacturer's products exceeds a certain value so that manufacturers can distribute their content while stimulating users to buy.

A twelfth aspect of the invention provides a content distribution system according to any one of the first to sixth aspects, wherein the decryption key is given to the winner of a lottery held at the time of purchasing products from the single manufacturer or the plurality of manufacturers.

According to the twelfth aspect of the invention, the decryption key is given to the winner of a lottery held at the time of purchasing products from the single manufacturer or the plurality of manufacturers, so that manufacturers can distribute their content while stimulating users to buy.

A thirteenth aspect of the invention provides a content distribution system according to any one of the first to sixth aspects, wherein the content distributed by the information distribution device includes content which was created for private television broadcast by adding commercial messages, but the commercial messages have been removed.

According to the thirteenth aspect of the invention, content distributed by the information distribution device includes content which was created for private television broadcast by adding commercial messages, but the commercial messages have been removed. Therefore, the content making cost can reduced because there is no need to create new content.

A fourteenth aspect of the invention provides a content distribution system according to any one of the first to sixth aspects, wherein the decryption key is given in accordance with information sent to manufacturers, which information comprises requests related to products purchased from the single or the plurality of manufacturers, impressions after using the products, the recommended price.

A fifteenth aspect of the invention provides a content distribution system according to any one of the first to sixth aspects, wherein the decryption key is given in accordance with information sent to manufacturers, which information comprises buyer's age, sex, purchasing motive, etc.

According to the fourteenth or fifteenth aspect of the invention, consumers send to manufacturers product information comprising requests related to products, impressions after using the products, the recommended price or consumer information comprising consumer's age, sex, purchasing motive, etc. which thus helps manufacturers to understand more easily consumer trends and at the same time helps provide important guidance as far as development of future products is concerned. Also, consumers can enlarge the scope of viewable content and the viewing time and can also view different content.

A sixteenth aspect of the invention provides a content distribution system according to any one of the first to sixth aspects, wherein a decryption key is given in accordance with the information including requests for certain content or for viewing time which are sent to a content holder that has an information distribution device.

According to the sixteenth aspect of the invention, information comprising impressions or content requests for the future, etc. regarding content viewed by audience is sent to the content holder, thus helping the content holder to understand more easily audience's preferences and at the same time helping provide important guidance as far as making of future content is concerned. Also, audience can enlarge the scope of viewable content and the viewing time and can also view different content.

A seventeenth aspect of the invention provides a content distribution method comprising an encryption distribution step of encrypting and distributing via interactive media content made by the content holder using a budget provided by the single manufacturer or the plurality of manufacturers, an input step of inputting a decryption key given owing to purchase of products made by the manufacturers, a sending step of sending, upon input of the decryption key in the input process, the inputted decryption key, a determination step of receiving the decryption key sent in the sending step and determining whether the received decryption key is appropriate or not, a decryption step of decrypting, in case it was determined that the decryption key is appropriate in the determination step, the content distributed in the encryption distribution step, a receiving step of receiving the content sent in the encryption distribution step and a viewing step of reproducing the content received in the receiving step.

An eighteenth aspect of the invention provides a content distribution method comprising an encryption distribution step of encrypting and distributing content made by a content holder using a budget provided by a single or a plurality of manufacturers, a receiving step of receiving the content sent in the encryption distribution step, an input step of inputting a decryption key given owing to purchase of products made by the manufacturers, a decryption step of decrypting, upon inputting the decryption key in the input step, the content received in the receiving step, and a viewing step of reproducing the content decrypted in the decryption step.

According to the seventeenth or eighteenth aspect of the invention, the content holder can permit the user that purchased products from manufacturers to view the content, so that the correlation between content and user becomes stronger and manufacturer's investment efficiency in content increases.

A nineteenth aspect of the invention provides a content receiving device which is a device for receiving and reproducing content created by a content holder using a budget provided by a single manufacturer or a plurality of manufacturers and comprises input means for inputting a decryption key given owing to purchase of a product made by the manufacturer, sending means for sending, upon input of the decryption key by the input means, the inputted decryption key to the content holder, receiving means for receiving the content that the content holder decrypts by use of the received decryption key and then sends, and viewing means for reproducing the content received by the receiving means.

A twentieth aspect of the invention provides a content receiving device which is a device for receiving and reproducing decrypted content originally created by a content holder using making budget provided by a single manufacturer or a plurality of manufacturers and comprises receiving means for receiving the content, input means for inputting a decryption key given owing to purchase of manufacturer's product, decryption means for decrypting, upon input of the decryption key by the input means, an encryption of the content received by the receiving means by use of the decryption key, and viewing means for reproducing the content decrypted by the decryption means.

According to the nineteenth or twentieth aspect of the invention, a content holder can permit a user that purchased products from manufacturers to view content, so that the correlation between content and user becomes stronger and investment efficiency in content increases. The present invention has been fully described. However, the above description is merely by the way of example, and it is not limited thereto. It is therefore to be understood that various changes and modifications which are not discussed herein can be considered without departing from the spirit of the invention.

### INDUSTRIAL APPLICABILITY

The content distribution system, the content distribution method and the content receiving device according to the invention enable increasing the investment efficiency relating to content, hence bringing industrial benefits.

1-20. (canceled)

21. A content distribution system comprising an information distribution device, a manufacturer terminal and a content receiving device which are connectable with one another via a communications line, wherein:
the information distribution device includes
an encryption distribution means for encrypting and distributing a content;
the content receiving device includes
a product purchase information input means for accepting an input of product purchase information; and
a product purchase information sending means for sending the received product purchase information to the manufacturer terminal;
the manufacturer terminal includes
a product purchase information receiving means for receiving the sent product purchase information; and
a decryption key delivery means which includes a first memory for storing a decryption key, and which, upon receiving the product purchase information, reads the decryption key from the first memory and delivers it to the content receiving device,
the content receiving device includes
a decryption key receiving means for receiving the decryption key delivered by the manufacturer terminal;
a decryption key storage means having a second memory, and adapted for storing the received decryption key in the second memory;
an input means for accepting an operation which enables use of the decryption key stored in the second memory; and
a decryption key sending means which, upon receiving the operation from the input means, reads the decryption key from the second memory and sends it to the information distribution device;
the information distribution device further includes
a decryption means which receives the decryption key sent from the decryption key sending means and uses the received decryption key to decrypt the content distributed by the encryption distribution means;
the content receiving means further includes
a content receiving means for receiving the content sent by the encryption distribution means; and
an audiovisual means for reproducing the content received by the content receiving means.

22. A content distribution system comprising an information distribution device, a manufacturer terminal and a content receiving device which are connectable with one another via a communications line, wherein:
the information distribution device includes
an encryption distribution means for encrypting and distributing a content;
the content receiving device includes
a product purchase information input means for accepting an input of product purchase information; and
a product purchase information sending means for sending the received product purchase information to the manufacturer terminal;
the manufacturer terminal includes
a product purchase information receiving means for receiving the sent product purchase information; and
a decryption key delivery means which includes a first memory for storing a decryption key, and which, upon receiving the product purchase information, reads the decryption key from the first memory and delivers it to the content receiving device;
the content receiving devices comprising
a content receiving means for receiving the content sent from the encryption distribution means;
a decryption key receiving means for receiving the decryption key delivered by the manufacturer terminal;
a decryption key storage means including a second memory, and adapted for storing the received decryption key in the second memory;
an input means for accepting an operation which enables use of the decryption key stored in the second memory;
a decryption means which, upon accepting the operation from the input means, reads the decryption key from the second memory and uses it to decrypt the content received by the content receiving device; and
an audiovisual means for reproducing the content decrypted by the decryption means.

23. A content distribution system comprising an information distribution device and a content receiving device which are connectable with each other via a communications line, a consumer terminal and a manufacturer terminal which are connectable with each other via a communications line, wherein:
the information distribution device includes
an encryption distribution means for encrypting and distributing a content;
the consumer terminal includes
a product purchase information input means for accepting an input of product purchase information; and
a product purchase information sending means for sending the received product purchase information to the manufacturer terminal;
the manufacturer terminal includes
a product purchase information receiving means for receiving the sent product purchase information; and
a decryption key delivery means which includes a first memory for storing a decryption key and which, upon receiving the product purchase information, reads the decryption key from the first memory and delivers it to the consumer terminal;
the consumer terminal includes
a decryption key receiving means for receiving the decryption key delivered by the manufacturer terminal;
the content receiving device includes
an input means for accepting an input of the decryption key received by the consumer terminal;
a decryption key sending means which, upon accepting the input from the input means, sends the decryption key to the information distribution device;
the information distribution device includes
a decryption means which receives the decryption key sent by the decryption key sending means and uses the received decryption key to decrypt the content distributed by the encryption distribution means;
the content receiving device includes
a content receiving means for receiving the content sent by the encryption distribution means; and
an audiovisual means for reproducing the content received by the content receiving means.

24. A content distribution system comprising an information distribution device and a content receiving device which are connectable with each other via a communications line, a consumer terminal and a manufacturer terminal which are connectable with each other via a communications line, wherein
the information distribution device includes
an encryption distribution means for encrypting and distributing a content;
the consumer terminal includes
a product purchase information input means for accepting an input of product purchase information; and
a product purchase information sending means for sending the received product purchase information to the manufacturer terminal;
the manufacturer terminal includes
a product purchase information receiving means for receiving the sent product purchase information; and
a decryption key delivery means which includes a first memory for storing a decryption key and which, upon receiving the product purchase information, reads the decryption key from the first memory and delivers it to the consumer terminal;
the consumer terminal includes
a decryption key receiving means for receiving the decryption key delivered by the manufacturer terminal;
the content receiving device includes
a content receiving means for receiving the content sent by the encryption distribution means;
an input means for accepting an input of the decryption key received by the consumer terminal,
a decryption means which, upon accepting the input from the input means, uses the decryption key to decrypt the content received by the content receiving means, and
an audiovisual means for reproducing the content decrypted by the decryption means.

25. A content distribution system comprising:
an information distribution device including an encryption distribution means for encrypting and distributing via an interactive medium content created by a content holder using a budget provided by a single manufacturer or a plurality of manufacturers and a decryption means which receives a decryption key given owing to purchase of a product made by the manufacturer and decrypts the content distributed by the encryption distribution means; and
a content receiving device including an input means for inputting a decryption key given owing to purchase of a product made by the manufacturer, a sending means which, after the decryption key is inputted by the input means, sends the inputted decryption key to the information distribution device, a receiving means for receiving the content sent by the information distribution device and an audiovisual means for reproducing the content received by the receiving means.

26. A content distribution system comprising:
an information distribution device including an encryption distribution means for encrypting and distributing content created by a content holder using a budget provided by a single manufacturer or a plurality of manufacturers; and
a content receiving device including a receiving means for receiving the content sent from the information distribution device, an input means for inputting a decryption key given owing to purchase of a product made by the manufacturer, a decryption means which, upon input of the decryption key from the input means, decrypts the content received by the receiving means, and an audiovisual means for reproducing the content decrypted by the decryption means.

27. The content distribution system defined in claim 25, wherein the decryption key is given in accordance with the price of products purchased from the single or the plurality of manufacturers or the quantity of the purchased products.

28. The content distribution system defined in claim 25, wherein the decryption key is given in accordance with points which are allotted in accordance with the price of a product purchased from the single manufacturer or the plurality of manufacturers or the quantity of the purchased products.

29. The content distribution system defined in claim 25, wherein the decryption key is set according to each content or to a viewable time of the content.

30. The content distribution system defined in claim 25, wherein the decryption key given according to a specific product purchased from the single or the plurality of manufacturers is allowed to be used only for decrypting a specific content.

31. The content distribution system defined in claim 25, wherein the decryption key given in advance owing to product purchase is allowed to be used when the selling quantity of products made by the manufacturer exceeds a certain value.

32. The content distribution system defined in claim 25, wherein the decryption key is given to a winner of a lottery held at the time of purchasing products from the single manufacturer or the plurality of manufacturers.

33. The content distribution system defined in claim 25, wherein the content distributed by the information distribution device is content which was created for private television broadcast by adding commercial messages, but the commercial messages have been removed.

34. The content distribution system defined in claim 25, wherein the decryption key is given in accordance with information sent to manufacturers, which information comprises requests related to products purchased from the single manufacturer or the plurality of manufacturers, impressions after using the products, recommended price.

35. The content distribution system defined in claim 25, wherein the decryption key is given in accordance with information sent to manufacturers, which information comprises buyer's age, sex, purchasing motive.

36. The content distribution system defined in claim 25, wherein the decryption key is given in accordance with information including preferences for certain content or for viewing time which is sent to the content holder that has the information distribution device.

37. A content distribution method comprising:
an encryption distribution step of encrypting and distributing via an interactive medium content made by a content holder using a budget provided by a single manufacturer or a plurality of manufacturers;
an input step of inputting a decryption key given owing to purchase of a product made by the manufacturer;
a sending step of sending, upon input of the decryption key in the input step, the inputted decryption key;
a determination step for receiving the decryption key sent in the sending step and determining whether the received decryption key is appropriate or not;
a decryption step for decrypting, in case it was determined in the determination step that the decryption key is appropriate, the content distributed in the encryption distribution step;
a receiving step of receiving the content sent in the encryption distribution step; and
a viewing step of reproducing the content received in the receiving step.

38. A content distribution method comprising:
an encryption distribution step of encrypting and distributing a content made by a content holder using a budget provided by a single manufacturer or a plurality of manufacturers;
a receiving step of receiving the content sent in the encryption distribution step;
an input step of inputting a decryption key given owing to purchase of a product made by the manufacturer;
a decryption step of decrypting, upon inputting the decryption key in the input step, the content received in the receiving step; and
a viewing step of reproducing the content decrypted in the decryption step.

39. A content receiving device for receiving and reproducing a content created by a content holder using a budget provided by a single manufacturer or a plurality of manufacturers, comprising:
an input means for inputting a decryption key given owing to purchase of a product made by the manufacturer;
a sending means for sending, upon input of the decryption key by the input means, the inputted decryption key to the content holder;
a receiving means for receiving the content that the content holder decrypts using the received decryption key and sends; and
a viewing means for reproducing the content received by the receiving means.

40. A content receiving device for receiving and reproducing decrypted content originally created by a content holder using a budget provided by a single manufacturer or a plurality of manufacturers, comprising:
a receiving means for receiving the content;
an input means for inputting a decryption key given owing to purchase of a product made by the manufacturer;
a decryption means for decrypting, upon input of the decryption key by the input means, an encryption of the content received by the receiving means by use of the decryption key; and
a viewing means for reproducing the content decrypted by the decryption means.
